(19) United States
(12) Patent Application Publication
(10) Pub. No.: US 2025/0176017 A1
(43) Pub. Date: May 29, 2025

(54) SHARING THE CHANNEL ACCESS OCCUPANCY TIME AMONG DEVICES IN NEW RADIO (NR) SIDELINK OPERATING IN FREQUENCY RANGE 1 (FR-1) UNLICENSED BAND

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/833,340

(22) PCT Filed: Apr. 17, 2023
(86) PCT No.: PCT/US2023/065839

§ 371 Date: Jul. 25, 2024

Related U.S. Application Data
(60) Provisional application No. 63/332,098, filed on Apr. 18, 2022.
(60) Provisional application No. 63/349,871, filed on Jun. 7, 2022.
(60) Provisional application No. 63/407,298, filed on Sep. 16, 2022.

(51) Int. Cl. H04W 74/0808; H04W 74/00; H04W 92/18

(52) U.S. Cl. CPC H04W 74/0808; H04W 74/002; H04W 92/18

(57) ABSTRACT

Various embodiments herein relate to identifying an indication of a channel access priority class (CAPC); identifying, based on the CAPC and a table related to the CAPC, a length of a channel occupancy time (COT); and participating in a sidelink (SL) communication in the unlicensed spectrum based on the COT. Other embodiments may be described and/or claimed.

### CROSS REFERENCE TO RELATED APPLICATION

The present application claims priority to U.S. Provisional Patent Application No. 63/332,098, which was filed Apr. 18, 2022; U.S. Provisional Patent Application No. 63/349,871, which was filed Jun. 7, 2022; and to U.S. Provisional Patent Application No. 63/407,298, which was filed Sep. 16, 2022.

### FIELD

Various embodiments generally may relate to the field of wireless communications. For example, some embodiments may relate to channel occupancy time (COT) in wireless networks.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example overview of new radio-unlicensed (NR-U) sidelink (SL) communication modes, in accordance with various embodiments.

FIG. 2 illustrates an example of Mode-1-a COT sharing by a gNodeB (gNB), in accordance with various embodiments.

FIG. 3 illustrates an example of COT initiation between two user equipments (UEs), in accordance with various embodiments.

FIG. 4 illustrates an alternative example of COT initiation between two UEs, in accordance with various embodiments.

FIG. 5 illustrates an alternative example of COT initiation between two UEs, in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 illustrates an example network, in accordance with various embodiments.

FIG. 10 depicts an example procedure for practicing the various embodiments discussed herein.

FIG. 11 depicts another example procedure for practicing the various embodiments discussed herein.

FIG. 12 depicts another example procedure for practicing the various embodiments discussed herein.

FIG. 13 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, fifth generation (5G) (which may be additionally or alternatively referred to as new radio (NR)) may provide access to information and sharing of data anywhere, anytime by various users and applications. NR may be a unified network/system that target to meet vastly different and sometime conflicting performance dimensions and services. Such diverse multi-dimensional requirements may be driven by different services and applications.

For instance, in the third generation partnership project (3GPP) release-16 (Rel. 16) specifications, sidelink (SL) communication was developed in part to support advanced vehicle-to-anything (V2X) applications. In release-17 (Rel. 17), 3GPP studied and standardized proximity based services including public safety and commercial related services and, as part of Rel. 17, power saving solutions (e.g., partial sensing, discontinuous reception (DRX), etc.) and inter-UE coordination have been developed in part to improve power consumption for battery limited terminals and reliability of SL transmissions. Although NR SL was initially developed for V2X applications, there is growing interest in the industry to expand the applicability of NR SL to commercial use cases, such as sensor information (video) sharing between vehicles with high degree of driving automation. For commercial SL applications, two desirable elements may include:
Increased SL data rate
Support of new carrier frequencies for SL

To achieve these elements, one objective in release-18 (Rel. 18) is to extend SL operation in unlicensed spectrum, which may be referred to as “NR-U SL” herein. However, it may be noted that to allow fair usage of the spectrum and fair coexistence among different technologies, different regional regulatory requirements are imposed worldwide. Thus, to enable a solution for all regions complying with the strictest regulation from the European Telecommunications Standards Institute (ETSI) Broadband Radio Access Networks (BRAN) committee published in European Standard (EN) 301 893 may be sufficient. In fact, for the development of NR-U during Rel. 16 a 3GPP NR based system complying with these regulations was developed.

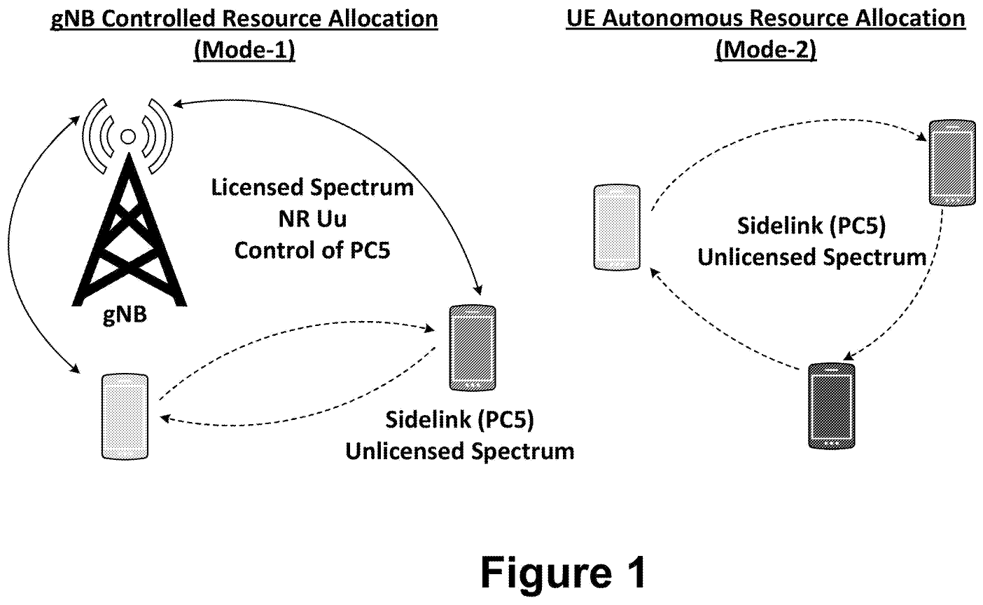

With that said, to enable a SL communication system in the unlicensed band, the considerations of SL communication systems may need to be combined with the regulator requirements necessary for the operation in the unlicensed bands. In particular, it may be noted that NR SL could be operated through two modes of operation: 1) mode-1, where a gNB schedules the SL transmission resource(s) to be used by the UE, and Uu operation is limited to licensed spectrum only; and/or 2) mode-2, where a UE determines (i.e, gNB does not schedule) the SL transmission resource(s) within SL resources which are configured by the gNB/network or pre-configured. FIG. 1 illustrates examples of the above-described two modes of operation.

In this context, there are several specific challenges to enable NR-U SL. One challenge relates to the use of a channel occupancy time (COT) once a device is able to acquire it: in fact, when a device operating as an initiating device performs a listen before talk (LBT) procedure before performing a transmission and assesses that the channel is idle, it is entitled to use that channel for the whole duration of a maximum COT, which when the device is operating in dynamic channel access mode and performs type 1 LBT, depends on the channel access priority class (CAPC) used. In particular, example values (such as may be related to requirements provided by the broadband radio access network (BRAN) committee of the European Telecommunications Standards Institute (ETSI) for uplink (UL)) are provided in the Table IA, while example values related to downlink (DL) are depicted in Table IB.

TABLE IA
Example relationship between CAPC and MCOT for
dynamic channel access mode for UL.

| Channel Access Priority | |
|---|---|
| Class (p) | T_{MCOT} |
| 1 | 2 ms |
| 2 | 4 ms |
| 3 | 6 ms or 10 ms |
| 4 | 6 ms or 10 ms |

NOTE 1:
For p = 3, 4, T_{MCOT} = 10 ms if the higher layer parameter absenceOfAnyOtherTechnology-r14 or absenceOfAnyOtherTechnology-r16 is provided, otherwise, T_{MCOT} = 6 ms.

TABLE IB
Example relationship between CAPC and MCOT for dynamic
channel access mode for DL.

| Channel Access Priority | |
|---|---|
| Class (p) | T_{MCOT} |
| 1 | 2 ms |
| 2 | 3 ms |
| 3 | 8 or 10 ms |
| 4 | 8 or 10 ms |

Additionally, when the device is operating in semi-static channel access mode, such mode may be considered to be equivalent to the configured fixed frame period (FFP).

In order to allow a system to fully utilize a COT once it is acquired, the regulatory requirements mandated by the ETSI BRAN and published in EN 301 893 allow an initiating device that is able to acquire a COT to be able to share it with other devices, which may act as a responding device, and allow within this laps of time the responding device to transmit, and to even skip sensing the channel if the gap between transmissions are less than 16 microseconds (us). In compliance to this feature and related restrictions, in Rel. 16 NR-U the concept of COT sharing was introduced, wherein either a gNB or a UE can share their COT to other UEs or to the gNB, respectively. When the COT is shared, other transmissions from the initiating device or transmissions from another responding device may occur if one or more of the following example factors is true (while other embodiments may use additional or alternative factors):
when the device is operating in dynamic channel access mode
   If the gap between two transmission bursts is less than 16 us, and the second transmission is not longer than 584 us, and the second transmission falls within the initiating device maximum COT (MCOT);
   If the gap between two transmission bursts is larger than 16 us, but shorter than 25 us, the device performing the second transmission burst is able to assess that the channel is idle via type-2B LBT (a.k.a 16 us LBT) and the second transmission falls within the initiating device MCOT;
   If the gap between two transmission bursts is larger than 25 us, the device performing the second transmission burst is able to assess that the channel is idle via type-2A LBT (a.k.a 25 us LBT) and the second transmission falls within the initiating device MCOT.
when the device is operating in semi-static channel access mode
   If the gap between two transmission bursts is less than 16 us, and the second transmission falls within the initiating device FFP;
   If the gap between two transmission bursts is larger than 16 us, and the device performing the second transmission burst is able to assess that the channel is idle via a single sensing window of X us, where x=9 us, except for China where X=16 us, and the second transmission falls within the initiating device FFP.

Moving forward to Rel. 18 SL communication, it may also be desirable, for better spectrum utilization and to guarantee competitiveness with other incumbent technologies, to enable this feature and more importantly to extend this procedure to SL links, where a UE should be able to share its COT with other UEs, rather than imposing each UE to independently acquire their COTs. Imposing each UE to independently acquire their COTs may:
1. Increase congestion within a SL system, given that every UE will be competing not only with device belonging to other incumbent technologies, but also with other UEs for the spectrum;
2. Reduce spectrum efficiency and increase overall LBT overhead within a SL system.

Multiple options on how this feature should be enabled are provided in the following of this disclosure, and separate embodiments are provided for mode 1 and mode 2.

### SL COT Sharing Procedure for Mode-1

Before discussing any enhancement for mode 1, it may be desirable to decouple the problem based on the possible deployments, and on how mode 1 may be possibly working in unlicensed spectrum. The following are non-limiting examples of such:
Mode-1-a: gNB sends scheduling downlink control information (DCI) on a licensed carrier, and can perform sensing on SL unlicensed carrier, and transmit on SL unlicensed carrier
   It can sense the SL channel and transmit on SL carrier to occupy the channel and then share a COT it with UE(s).
Mode-1-b: gNB sends scheduling DCI on a licensed carrier, and can perform sensing on the SL unlicensed carrier, but cannot transmit on the SL unlicensed carrier
   It can sense the SL channel, but cannot occupy by its own transmission;
   SL UEs and gNB may listen for DCI on licensed carrier to assess channel occupation by gNB.
Mode-1-c: gNB sends scheduling DCI on licensed carrier, and cannot perform sensing on SL unlicensed carrier, and cannot transmit on SL unlicensed carrier:
   It does not have idea about SL carrier channel occupations and cannot occupy it by its own signals

### COT Sharing Procedure for Mode 1-a

As discussed above for SL communication without COT sharing, a UE may need to perform an LBT procedure (which for dynamic channel access mode would require type 1 LBT with random backoff) before each transmission, which may not be very spectrum efficient. Thus, support for SL communication with COT sharing may be desirable, and a specific framework should be defined. However, based on the intended deployment, the COT sharing mechanism may need to be enabled differently. In this section, embodiments may relate to the COT sharing procedure for mode 1-a. While mode 1-b and 1-c assume that the gNB may only transmit in licensed spectrum, for mode 1-a the gNB can additionally transmit in the unlicensed spectrum, similarly as Rel. 16 and Rel. 17 NR-U in FR-1.

gNB's Controlled Shared COT (DL-to-UL & UL-to-DL) for Mode 1-a

In this sub-section, embodiments may relate to a gNB's controlled shared COT and specifically on DL-to-UL and UL-to-DL COT sharing and decouple discussion between the case when the UL is a dynamic grant (DG) UL or a configured grant (CG) UL.

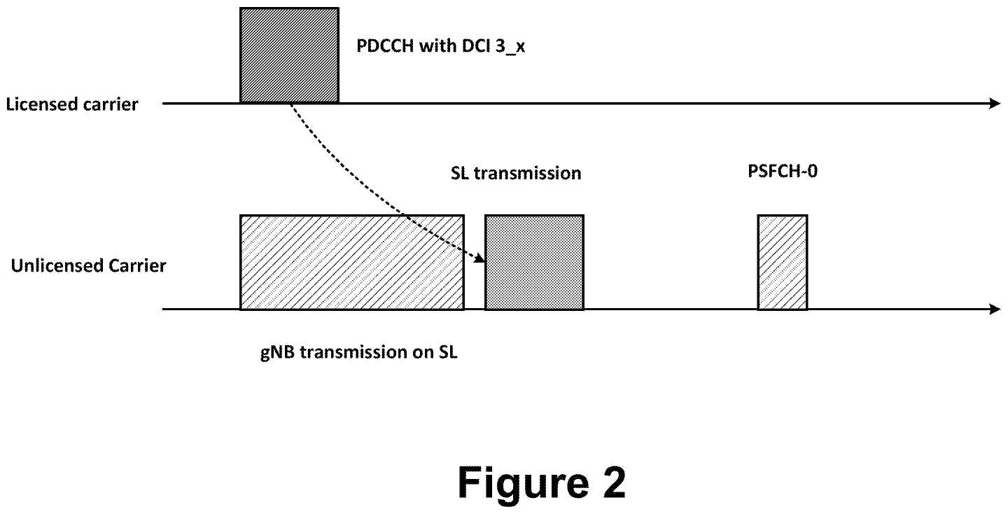

However before discussing the two procedures in detail, in order to realize Mode-1-a, one or more of the following example options could be employed:
In one embodiment, a reservation signal is transmitted from gNB on the unlicensed SL band. This may be realized by a specific gNB SL signal, which is used to reserve the medium in SL, while the control channel is still transmitted in licensed band as illustrated in FIG. 2.
In another embodiment, a gNB transmits both control and shared channel in unlicensed band, and the signal used by the gNB to reserve/occupy the unlicensed carrier may be composed by the PDCCH carrying DCI 3_x.
In a third embodiment, a gNB transmitting a normal transmission to a UE operating in the unlicensed band. The scheduling is in this case relative to when the gNB acquires the channel and initiates a shared COT.

### Dynamic Grant (DG) UL

For mode 1-a, the NR-U COT sharing procedure defined in Rel-16 and Rel-17 for FR-1 (which may refer to frequency bands up to approximately 6 gigahertz (GHz) or, in other embodiments, 7 GHZ) may be reused, and both gNB-to-UE shared COT and UE-to-gNB shared COT may be enabled for dynamic grant transmissions by carrying the channel access field defined in Rel-16 and Rel-17 for both UL and DL fall-back and non-fall back DCIs also in DCI 3_0 and 3_1.

However, in this case, one or both of the following two example approaches may be used:
In one embodiment, timing advance (TA) of the UEs is known and used by the gNB to properly schedule the UL transmissions and instruct the UE about the channel access procedure to perform.
In another embodiment, the UEs and gNB only utilize the DL timing for the aim to instruct a UE about the channel access procedure to perform.

If the first approach is used (e.g., the TA approach), given that in this case the gNB may exactly know the timing and gaps across all DL and UL transmissions within the unlicensed carrier(s), also including the UU links, as in Rel-16 and Rel-17 the scheduling DCIs should be enhanced so that to contain a specific field which may jointly indicate one or more of the following:
for dynamic channel access mode the cyclic prefix (CP) extension/CAPC and LBT type to use;
for semi-static channel access mode the LBT type/CP extension and COT initiator.

In this matter:

In one embodiment, DCI 3_0 may be enhanced as follows:
Option 1: DCI 3_0 includes a ChannelAccess-CPext field (as included in DCI 0_0/1_0/2_0), which is composed by 2 bits indicating combinations of channel access type and CP extension as defined in Table II if the system operate in dynamic channel access mode, or Table III if the system operates in semi-static channel access more, and 0 bit if the system operates in licensed band.
   This field maybe either added by refurbishing unused bits from fields that are no longer needed when operating in unlicensed band, or could be added as a separate field. In any case, there may be no need to maintain the same payload with the DCI 3_0 in licensed carrier, since through channelization a UE may be able to know whether it operates in licensed or unlicensed spectrum.

TABLE II
Example channel access type & CP extension for DCI format
3_0 for dynamic channel access mode

| | | The CP extension |
|---|---|---|
| | | T_“ext” index defined in |
| Bit field mapped | | Clause 5.3.1 of [4, TS |
| to index | Channel Access Type | 38.211] |
| 0 | Type2C-ULChannelAccess | 2 |
| | defined in [clause 4.2.1.2.3 | |
| | in 37.213] | |
| 1 | Type2A-ULChannelAccess | 3 |
| | defined in [clause 4.2.1.2.1 | |
| | in 37.213] | |
| 2 | Type2A-ULChannelAccess | 1 |
| | defined in [clause 4.2.1.2.1 | |
| | in 37.213] | |
| 3 | Type1-ULChannelAccess | 0 |
| | defined in [clause 4.2.1.1 in | |
| | 37.213] | |

TABLE III
Example channel access type & CP extension for DCI format
3_0 for semi-static channel access mode

| | | The CP extension | Initiator of the |
|---|---|---|---|
| | | T_“ext” index | channel occupancy |
| | | defined | associated with the |
| Bit field | | in Clause | UL transmission as |
| mapped | | 5.3.1 of [4, TS | described in Clause |
| to index | Channel Access Type | 38.211] | x.x in TS 37.213 |
| 0 | No sensing as defined | 0 | gNB |
| | in Clause 4.3 in TS | | |
| | 37.213 | | |
| 1 | No sensing as defined | 2 | gNB |
| | in Clause 4.3 in TS | | |
| | 37.213 | | |
| 2 | Sensing within a 25 us | 0 | gNB |
| | interval as defined in | | |
| | Clause 4.3 in TS | | |
| | 37.213 | | |
| 3 | Sensing as defined in | 0 | UE |
| | Clause 4.3.1.2 in TS | | |
| | 37.213 | | |

Note:
Row index 3 is only applicable if ue-SemiStaticChannelAccessConfig is provided. Otherwise, the row is reserved.

Option 2: DCI 3_0 includes a ChannelAccess-CPext-CAPC field (as included in DCI 0_1/1_1/2_1), which is composed by 2 bits indicating combinations of channel access type, CP extension and COT initiator as defined in Table III, if ChannelAccessMode-r16=“semistatic” is provided, and the system operate in semi-static channel access mode. This field is instead, 0, 1, 2, 3, 4, 5 or 6 bits if ChannelAccessMode-r16 is not provided or ChannelAccessMode-r16=“dynamic”, and in this case the bitwidth for this field is determined as [log₂ (I)] bits, where I is the number of entries in a new higher layer parameter ul-AccessConfigListDCI-3-0, where one or more entries from Table IV are configured by the higher layer parameter ul-AccessConfigListDCI-3-0. Otherwise, this field is 0 bits.
   This field may be either added by refurbishing unused bits from fields that are no longer needed when operating in unlicensed band or could be added as a separate field. In any cases, it is important to note that there is no need to maintain the same payload with the DCI 3_0 in licensed carrier, since through channelization a UE may be able to know whether it operates in licensed or unlicensed spectrum.

TABLE IV
Example allowed entries for DCI format 3_0, configured by higher layer
parameter ul-AccessConfigListDCI-3-0

| | | The CP extension | |
|---|---|---|---|
| | | T_“ext” index | |
| Entry | | defined in Clause | |
| index | Channel Access Type | 5.3.1 of [4, 38.211] | CAPC |
| 0 | Type2C-ULChannelAccess defined in [clause 4.2.1.2.3 | 0 | 1 |
| | in 37.213] | | |
| 1 | Type2C-ULChannelAccess defined in [clause 4.2.1.2.3 | 0 | 2 |
| | in 37.213] | | |
| 2 | Type2C-ULChannelAccess defined in [clause 4.2.1.2.3 | 0 | 3 |
| | in 37.213] | | |
| 3 | Type2C-ULChannelAccess defined in [clause 4.2.1.2.3 | 0 | 4 |
| | in 37.213] | | |
| 4 | Type2C-ULChannelAccess defined in [clause 4.2.1.2.3 | 2 | 1 |
| | in 37.213] | | |
| 5 | Type2C-ULChannelAccess defined in [clause 4.2.1.2.3 | 2 | 2 |
| | in 37.213] | | |
| 6 | Type2C-ULChannelAccess defined in [clause 4.2.1.2.3 | 2 | 3 |
| | in 37.213] | | |
| 7 | Type2C-ULChannelAccess defined in [clause 4.2.1.2.3 | 2 | 4 |
| | in 37.213] | | |
| 8 | Type2B-ULChannelAccess defined in [clause 4.2.1.2.3 | 0 | 1 |
| | in 37.213] | | |
| 9 | Type2B-ULChannelAccess defined in [clause 4.2.1.2.3 | 0 | 2 |
| | in 37.213] | | |
| 10 | Type2B-ULChannelAccess defined in [clause 4.2.1.2.3 | 0 | 3 |
| | in 37.213] | | |
| 11 | Type2B-ULChannelAccess defined in [clause 4.2.1.2.3 | 0 | 4 |
| | in 37.213] | | |
| 12 | Type2B-ULChannelAccess defined in [clause 4.2.1.2.3 | 2 | 1 |
| | in 37.213] | | |
| 13 | Type2B-ULChannelAccess defined in [clause 4.2.1.2.3 | 2 | 2 |
| | in 37.213] | | |
| 14 | Type2B-ULChannelAccess defined in [clause 4.2.1.2.3 | 2 | 3 |
| | in 37.213] | | |
| 15 | Type2B-ULChannelAccess defined in [clause 4.2.1.2.3 | 2 | 4 |
| | in 37.213] | | |
| 16 | Type2A-ULChannelAccess defined in [clause 4.2.1.2.1 | 0 | 1 |
| | in 37.213] | | |
| 17 | Type2A-ULChannelAccess defined in [clause 4.2.1.2.1 | 0 | 2 |
| | in 37.213] | | |
| 18 | Type2A-ULChannelAccess defined in [clause 4.2.1.2.1 | 0 | 3 |
| | in 37.213] | | |
| 19 | Type2A-ULChannelAccess defined in [clause 4.2.1.2.1 | 0 | 4 |
| | in 37.213] | | |
| 20 | Type2A-ULChannelAccess defined in [clause 4.2.1.2.1 | 1 | 1 |
| | in 37.213] | | |
| 21 | Type2A-ULChannelAccess defined in [clause 4.2.1.2.1 | 1 | 2 |
| | in 37.213] | | |
| 22 | Type2A-ULChannelAccess defined in [clause 4.2.1.2.1 | 1 | 3 |
| | in 37.213] | | |
| 23 | Type2A-ULChannelAccess defined in [clause 4.2.1.2.1 | 1 | 4 |
| | in 37.213] | | |
| 24 | Type2A-ULChannelAccess defined in [clause 4.2.1.2.1 | 3 | 1 |
| | in 37.213] | | |
| 25 | Type2A-ULChannelAccess defined in [clause 4.2.1.2.1 | 3 | 2 |
| | in 37.213] | | |
| 26 | Type2A-ULChannelAccess defined in [clause 4.2.1.2.1 | 3 | 3 |
| | in 37.213] | | |
| 27 | Type2A-ULChannelAccess defined in [clause 4.2.1.2.1 | 3 | 4 |
| | in 37.213] | | |
| 28 | Type1-ULChannelAccess defined in [clause 4.2.1.1 in | 0 | 1 |
| | 37.213] | | |
| 29 | Type1-ULChannelAccess defined in [clause 4.2.1.1 in | 0 | 2 |
| | 37.213] | | |
| 30 | Type1-ULChannelAccess defined in [clause 4.2.1.1 in | 0 | 3 |
| | 37.213] | | |
| 31 | Type1-ULChannelAccess defined in [clause 4.2.1.1 in | 0 | 4 |
| | 37.213] | | |
| 32 | Type1-ULChannelAccess defined in [clause 4.2.1.1 in | 1 | 1 |
| | 37.213] | | |
| 33 | Type1-ULChannelAccess defined in [clause 4.2.1.1 in | 1 | 2 |
| | 37.213] | | |
| 34 | Type1-ULChannelAccess defined in [clause 4.2.1.1 in | 1 | 3 |
| | 37.213] | | |
| 35 | Type1-ULChannelAccess defined in [clause 4.2.1.1 in | 1 | 4 |
| | 37.213] | | |
| 36 | Type1-ULChannelAccess defined in [clause 4.2.1.1 in | 2 | 1 |
| | 37.213] | | |
| 37 | Type1-ULChannelAccess defined in [clause 4.2.1.1 in | 2 | 2 |
| | 37.213] | | |
| 38 | Type1-ULChannelAccess defined in [clause 4.2.1.1 in | 2 | 3 |
| | 37.213] | | |
| 39 | Type1-ULChannelAccess defined in [clause 4.2.1.1 in | 2 | 4 |
| | 37.213] | | |
| 40 | Type1-ULChannelAccess defined in [clause 4.2.1.1 in | 3 | 1 |
| | 37.213] | | |
| 41 | Type1-ULChannelAccess defined in [clause 4.2.1.1 in | 3 | 2 |
| | 37.213] | | |
| 42 | Type1-ULChannelAccess defined in [clause 4.2.1.1 in | 3 | 3 |
| | 37.213] | | |
| 43 | Type1-ULChannelAccess defined in [clause 4.2.1.1 in | 3 | 4 |
| | 37.213] | | |

In one embodiment, the DCI 3_0 may additionally include some information related to the COT sharing information so that the UE may be aware of whether a transmission is within or outside a gNB's shared COT and how long the remaining COT may be. In this matter, one of the following options could be supported:
Option 1: In order to make the UE aware of whether its transmission is within our outside of gNB's COT, an additional field could be included which indicates in a binary way whether the UL transmission lies within or outside the gNB's COT.
Option 2: In order to make the UE aware of whether its transmission is within or outside of gNB's COT, and how long the remaining COT is, two separate fields are introduced: one field which indicates in a binary way whether the UL transmission lies within or outside the gNB's COT, and another field which indicates how long is the remaining COT.
As a sub-option, a higher layer parameter could be introduced which may indicate a subset of values from a predefined list of possible remaining COT durations. In this matter, the field indicated in DCI 3_0 may refer to one of these predefined values by the network.
Option 3: In order to make the UE aware of whether its transmission is within or outside of gNB's COT, and how long the remaining COT is, an additional field could be included, which jointly indicates both information.
As a sub-option, an higher layer parameter could be introduced which may indicate a subset of values from a predefined list of possible remaining COT durations, and whether the remaining COT may belong to the UE or to the associated gNB. In this matter, the field indicated in DCI 3_0 may refer to one of these predefined values by the network.
Option 3: No additional information is need since the whole LBT type use is fully governed by the gNB, and the UE should not know whether its transmission belongs or not within a gNB's COT, or how long the remaining COT is.

In one embodiment, DCI 3_1 may be enhanced following one of the following options:
Option 1: DCI 3_1 may include a ChannelAccess-CPext field (as included in DCI 0_0/1_0/2_0), which is composed by 2 bits indicating combinations of channel access type and CP extension as defined in Table II, or Table III when ChannelAccessMode-r16=“semistatic” is provided. Otherwise, this field will be composed by 0 bit if the system operates in licensed band.
   Notice that this field could be either added by refurbishing unused bits from fields that are no longer needed when operating in unlicensed band, or could be added as a separate field. In any cases, it is important to note that it may not be necessary to maintain the same payload with the DCI 3_1 in licensed carrier, since through channelization a UE may be able to know whether it operates in licensed or unlicensed spectrum.
Option 2: DCI 3_1 may include a ChannelAccess-CPext-CAPC field (as included in DCI 0_1/1_1/2_1), which is composed by 2 bits indicating combinations of channel access type, CP extension and COT initiator as defined in Table III if ChannelAccessMode-r16=“semistatic” is provided. This field is instead, 0, 1, 2, 3, 4, 5 or 6 bits if ChannelAccessMode-r16 is not provided or ChannelAccessMode-r16=“dynamic”, and in this case the bitwidth for this field is determined as [log₂ (I)] bits, where/is the number of entries in a new higher layer parameter ul-AccessConfigListDCI-3-1, where one or more entries from Table IV are configured by the higher layer parameter ul-AccessConfigListDCI-3-1. Otherwise, this field is 0 bits.
   It will be noted that this field could be either added by refurbishing unused bits from fields that are no longer needed when operating in unlicensed band, or could be added as a separate field. In any cases, it is important to note that there is no need to maintain the same payload with the DCI 3_1 in licensed carrier, since through channelization a UE may be able to know whether it operates in licensed or unlicensed spectrum.

In one embodiment, the DCI 3_1 may additionally include some information related to the COT sharing information so that the UE may be aware of whether a transmission is within or outside a gNB's shared COT and how long the remaining COT may be. In this matter, one or more of the following example options could be supported:
Option 1: In order to make the UE aware of whether its transmission is within our outside of gNB's COT, an additional field could be included which indicates in a binary way whether the UL transmission lies within or outside the gNB's COT.
Option 2: In order to make the UE aware of whether its transmission is within or outside of gNB's COT, and how long the remaining COT is, two separate fields are introduced: one field which indicates in a binary way whether the UL transmission lies within or outside the gNB's COT, and another field which indicates how long is the remaining COT.
As a sub-option, an higher layer parameter could be introduced which may indicate a subset of values from a predefined list of possible remaining COT durations. In this matter, the field indicated in DCI 3_0 may refer to one of these predefined values by the network.
Option 3: In order to make the UE aware of whether its transmission is within or outside of gNB's COT, and how long the remaining COT is, an additional field could be included, which jointly indicates both information.
As a sub-option, an higher layer parameter could be introduced which may indicate a subset of values from a predefined list of possible remaining COT durations, and whether the remaining COT may belong to the UE or to the associated gNB. In this matter, the field indicated in DCI 3_0 may refer to one of these predefined values by the network.
Option 4: No additional information is need since the whole LBT type use is fully governed by the gNB, and the UE should not know whether its transmission belongs or not within a gNB's COT, or how long the remaining COT is.

In a different embodiment, a new DCI 3_X could be formed with the aim to carry some specific unlicensed information, which may include one or more of the following:
channel access type
CP extension
CAPC
COT initiator
COT sharing information, such as whether the COT is shared, and how long the remaining COT may be.

If the second approach is used (e.g., DL timing is used), one of the following options could be adopted:
Option 1: In one embodiment, it should be UE's responsibility to determine the appropriate gaps across bursts and determine the CP extension to apply and the right LBT type to use. However, it may be still up to gNB to indicate to the UE one or more of the following information:
   the CAPC to use
   whether the UE shall operate as initiating or responding device.

In this matter, this information may be carrier within either DCI 3_0 or DCI 3_1 or both.
Option 2: In one embodiment, the gNB may indicate within either DCI 3_0 or DCI 3_1 or both one or more of the following information:
   CAPC
   LBT type to use
   whether a device should operate as initiating or responding device (either explicitly for semi-static channel access mode or implicitly for dynamic channel access mode).

In this case, it is left up to the UE's to determine the gap across a prior burst and the UE's transmission and to apply the proper CP extension given the recommendation from the gNB to use a specific LBT type. If despite the recommendation, the UE is not able to follow the specific LBT type indicate by the gNB, one or more of the following example options could be supported:
Alt1: A UE may drop the transmission;
Alt2: Based on the CP extension that the UE is able to apply and based on the assessment from the UE regarding the gap across a prior burst and the UE's transmission, it is left up to UE's responsibility to choose a suitable LBT type that may comply with the regulatory requirements.

Notice that the embodiments listed here are not mutually exclusive, and one or more of them may be performed together.

### Configured Grant (CG) UL

For mode 1-a, for configured grant transmissions a UE should assess whether the transmission belongs on a gNB's COT or whether a new COT should be defined from DCI 2_0 information or prior DCI 3_x information (if carried in this DCIs), which may carry remaining COT information. In this case, the UE will independently choose the LBT type to adopt. However, when discussing the case when UE shares its own COT, separate considerations should be made based on whether the cg-RetransmissionTimer is enabled or disabled:
If cg-RetransmissionTimer is enabled, the UE may operate in an autonomous manner, and the gNB may not know the buffer occupancy status of the UE, therefore it may not know whether the configured resource will or will not be used by that UE. In one embodiment, in order to efficiently use the underutilized resources of the CG UE, the UE can indicate in the SL control information (SCI) (either stage 1 or stage 2 format or both or in a single stage SCI) one or more of the following information when applicable:
   CAPC (provided only for dynamic channel access mode);
   Starting symbol or slot of the unused resources;
   Amount of symbols or slots that the gNB can use.
      Notice that these fields could be either added by refurbishing unused bits from fields that are no longer needed when operating in unlicensed band or could be added as a separate field. In any cases, it is important to note that there is no need to maintain the same payload with the SCI in licensed carrier, since through channelization a UE may be able to know whether it operates in licensed or unlicenced spectrum.
If cg-RetransmissionTimer is disabled, then a UE does not perform any autonomous transmission, and therefore in this case the gNB is aware of the used resources, and no special handling is needed in this case. In this case, in one embodiment it is left up to gNB's implementation to configure properly the UL transmissions so that to maximize the spectrum utilization.
   It will be understood that the various embodiments listed here may not be mutually exclusive, and one or more of them may apply together.

### UL-to-UL COT Sharing Procedure for Mode 1-a

In this section, embodiments may relate to COT sharing across UEs, and will decouple the discussion between the case when the UL is a dynamic grant (DG) UL or a configured grant (CG) UL.

### Dynamic Grant (DG) UL

For mode 1-a, it should be also discussed whether UE-to-UE COT sharing should be allowed and in case how this should be enabled. In this sense, one of the following example options could be adopted:
Option 1—In one embodiment, UE-to-UE is not allowed for DG transmission for mode 1-a due to the interpretation of the regulatory requirements, since in this case coordination through gNB (who is able to transmit within the SL unlicensed spectrum) could be used.
Option 2—In one embodiment, UE-to-UE is allowed, and this feature may be enabled or disabled through either UE-specific or cell-specific RRC configuration or may be always enabled when operating in unlicensed spectrum.
Option 3—In one embodiment, UE-to-UE is allowed, and it could be left up to gNB to enable this procedure indicating properly to each UE the channel access information to use, and according to this indication a UE may operate as the initiating or responding device.

When UE-to-UE COT sharing is allowed, in order to make sure a responding device won't transmit if the initiating UE has not acquired the COT, it should be imposed that the responding UE may need to first ensure that the COT has been acquired by the initiating device. In this matter, whether operating in dynamic or semi-static channel access mode, the UE should be explicitly indicated in the DCI 3_0 and 3_1 whether it will operate as initiating or responding device.

In one embodiment, one or more of the following example options could be adopted:
Option A: a responding UE should be indicated by the gNB via DCI 3_0 or 3_1 which UE will be operating as the initiating device for the responding device burst, so that it can monitor transmission from such UE and make sure that regulation is not violated (i.e, responding device transmit within an acquired COT);
Option B: a UE should be indicated by the gNB via DCI 3_0 and/or DCI 3_1 whether that UE should operate as an initiating or responding device;
Option C: the SCI (either stage 1 or stage 2 format or both or a single stage SCI) carries a specific field which either duplicate the information provided by the gNB regarding whether it shall operate as initiating or responding device (this applies if both Option B and Option C are adopted together) or provides independently on the gNB indication whether it operate as initiating or responding device (this applies if Option C is not adopted together with Option B) so that at any time a UE will be indicating to other UEs whether it operates as initiating or responding device. In this matter, one of the following alternatives could be adopted:
   Alt 1: Information in SCI related to initiating and responding device can be retrieved by the UE from indication from the gNB via the channel access field: for instance, in dynamic channel access mode, the UE is imposed to perform type 1 LBT when initiating a COT, and this will be interpreted by the UE as if it shall operate as an initiating device, while in semi-static channel access mode this will be explicitly provided as in Table II.
   Alt 2: Given that DCI 3_0 or DCI 3_1 do not contain any additional information related to whether a UE will be operating as an initiating or responding device, information in SCI related to initiating and responding device is determined by a UE according to procedure defined below for mode 2.
      Additionally, in this case the SCI should also carry information for COT sharing such as
         CAPC (or PPPP if the two are coupled together);
         Indication on whether the COT will be shared or not
         Indication of the COT length
         Indication of shared resources
         1. Available resources
         2. Starting symbol/slot when resources could be used
         For semi-static channel access mode, the FFP configuration (FFP length and/or offset) could be also shared
         1. UE's Fixed frame period (FFP) length
         2. Offset value
      In some embodiments, these fields could be either added by refurbishing unused bits from fields that are no longer needed when operating in unlicensed band, or could be added as a separate field. In any cases, it is important to note that there is no need to maintain the same payload with the SCI in licensed carrier, since through channelization a UE may be able to know whether it operates in licensed or unlicenced spectrum.

It will be understood that the example embodiments listed here are not mutually exclusive, and one or more of them may apply together.

### Configured Grant (CG) UL

For mode 1-a for configured grant UL transmissions, it should be also discussed whether UE-to-UE COT sharing should be allowed and in case how this should be enabled. In this sense, in one embodiment, one or more of the following example options could be adopted:
Option 1—UE-to-UE is not allowed for CG transmission for mode 1-a regardless of whether the cg-Retransmission Timer is enabled or disabled.
Option 2—UE-to-UE is not allowed for CG transmission for mode 1-a when the cg-Retransmission Timer is disabled due to interpretation of the regulatory requirement, but UE-to-UE is allowed for CG transmission for mode 1-a when the cg-RetransmissionTimer is enabled. In this case, this feature may be enabled or disabled through either UE-specific, cell-specific RRC configuration or activation DCI, or may be always enabled when operating in unlicensed spectrum.
Option 3—UE-to-UE is allowed in all cases. In this case, this feature may be enabled or disabled through either UE-specific, cell-specific RRC configuration or activation DCI, or may be always enabled when operating in unlicensed spectrum.

In one embodiment, when UE-to-UE is enabled, the UE will independently choose the LBT type to adopt and will determine by itself by decoding other SL transmissions when and how to apply CP extension before its own transmission when it is needed.

In one embodiment, For a UE to indicate whether its COT can be shared or not sidelink control information (SCI) (either stage 1 or stage 2 format or both) must be enhanced and it shall contain one of more of the following information:
CAPC;
Indication on whether the current device is the initiating or responding device (this could be a single bit) and could be indicated for both dynamic and semi-static channel access mode or only for the second case;
Indication of remaining COT
   Granularity could be per slot or per symbol
   Indication could be via a combination of an RRC table and SCI field or SCI field only
      A specific indication can be reserved to indicate that the UE does not intend to share the COT (This could indicate type 0 sidelink COT sharing described in the following section)
   For semi-static channel access mode, the FFP configuration could be also shared
      Fixed frame period (FFP) length
      Offset value
Indication of the COT
   Duration of the COT, where the granularity could be per slot or per symbol
   Starting point of the COT, where the granularity could be per slot or per symbol
Destination ID, where this is equivalent to the source ID for unicast transmission, or it may be the same as the destination ID in SCI for the groupcast and broadcast transmission(s).
   Notice that these fields could be either added by refurbishing unused bits from fields that are no longer needed when operating in unlicensed band, or could be added as a separate field. In any cases, it is important to note that there is no need to maintain the same payload with the SCI in licensed carrier, since through channelization a UE may be able to know whether it operates in licensed or unlicenced spectrum.

In this case, for UE's behavior refer to procedures/rules defined for mode 2, since similar considerations may be applied here as well, while the behavior may be different or equal between mode 1 and mode 2. It will also be noted that the example embodiments listed here are not mutually exclusive, and one or more of them may apply together.

### COT Sharing Procedure for Mode 1-b and Mode 1-c

As mentioned in the prior section, for mode 1-b, the gNB may not be able to additionally transmit in the unlicensed spectrum. However, it may be able to sense the unlicensed spectrum, and coordinate in the best manner possible the transmissions in unlicensed spectrum. For mode 1-c, the gNB is instead not able to neither transmit in the unlicensed spectrum or to simply sense it. Therefore, the gNB may not be able to coordinate exactly UEs' transmissions in unlicensed spectrum but may perform a “blind” scheduling in terms of channel access.

Given that no DL transmission is performed in the unlicensed spectrum for both mode 1-b and 1-c, in one embodiment no COT sharing may be performed between a gNB and a UE regardless of the type of UL transmission (DG or CG): in other words neither DL-to-UL or UL-to-DL COT sharing can be supported. However, separate discussion should be made regarding the UE-to-UE COT sharing, which should be discussed separately on whether the initiating device performs an DG or CG UL transmission.

### Dynamic Grant (DG) UL

For mode 1-b and 1-c, it should be discussed whether UE-to-UE COT sharing should be allowed and in case how this should be enabled. In this sense, one of the following example options could be adopted:
Option 1—In one embodiment, UE-to-UE COT sharing is not allowed for DG transmission for mode 1-b due to the interpretation of the regulatory requirements since in this case coordination through gNB (who is able to transmit within the SL unlicensed spectrum) could be used.
Option 2—In one embodiment, UE-to-UE COT sharing is allowed, and this feature may be enabled or disabled through either UE-specific or cell-specific RRC configuration or may be always enabled when operating in unlicensed spectrum.
Option 3—In one embodiment, UE-to-UE COT sharing is allowed, and it could be left up to gNB to enable this procedure indicating properly to each UE the channel access information to use, and according to this indication a UE may operate as the initiating or responding device

When UE-to-UE COT sharing is allowed, in order to make sure a responding device won't transmit if the initiating UE has not acquired the COT, it should be imposed that the responding UE may need to first ensure that the COT has been acquired by the initiating device. In this matter, whether operating in dynamic or semi-static channel access mode, the UE should be explicitly indicated in the DCI 3_0 and 3_1 whether it will operate as initiating or responding device

In one embodiment, one or more of the following example options could be adopted:
Option A: a responding UE should be indicated by the gNB via DCI 3_0 or 3_1 which UE will be operating as the initiating device for the responding device burst, so that it can monitor transmission from such UE and make sure that regulation is not violated (i.e, responding device transmit within an acquired COT);
Option B: a UE should be indicated by the gNB via DCI 3_0 and/or DCI 3_1 whether that UE should operate as an initiating or responding device; This can include information how man responding device are scheduled in the same COT before the transmission of the current device (this can also be signal in the number of occupied time slots from the start of the shared COT).
Option C: the SCI (either stage 1 or stage 2 format or both or a single stage SCI) carries a specific field which either duplicate the information provided by the gNB regarding whether it shall operate as initiating or responding device (this applies if both Option B and Option C are adopted together) or provides independently on the gNB indication whether it operate as initiating or responding device (this applies if Option C is not adopted together with Option B) so that at any time a UE will be indicating to other UEs whether it operates as initiating or responding device. In this matter, one of the following alternatives could be adopted:
   Alt 1: Information in SCI related to initiating and responding device can be retrieved by the UE from indication from the gNB via the channel access field: for instance, in dynamic channel access mode, the UE is imposed to perform type 1 LBT when initiating a COT, and this will be interpreted by the UE as if it shall operate as an initiating device, while in semi-static channel access mode this will be explicitly provided as in Table II.
   Alt 2: Given that DCI 3_0 or DCI 3_1 do not contain any additional information related to whether a UE will be operating as an initiating or responding device, information in SCI related to initiating and responding device is determined by a UE according to procedure defined below for mode 2.
      Additionally, in this case the SCI should also carry information for COT sharing such as
         CAPC (or PPPP if the two are coupled together);
         Indication on whether the COT will be shared or not
         Indication of the COT length
         Destination ID, where this may be equivalent to the source ID for unicast transmission, or it may be the same as the destination ID in SCI for the groupcast and broadcast transmission(s). Indication of shared resources
         1. Available resources
         2. Starting symbol/slot when resources could be used
         For semi-static channel access mode, the FFP configuration (FFP length and/or offset) could be also shared
         1. UE's Fixed frame period (FFP) length
         2. Offset value
   Notice that these fields could be either added by refurbishing unused bits from fields that are no longer needed when operating in unlicensed band, or could be added as a separate field. In any cases, it is important to note that there is no need to maintain the same payload with the SCI in licensed carrier, since through channelization a UE may be able to know whether it operates in licensed or unlicenced spectrum.

It will be understood that the example embodiments listed here are not mutually exclusive, and one or more of them may apply together.

### Configured Grant (CG) UL

For mode 1-b and/or 1-c for configured grant UL transmissions, it should be also discussed whether UE-to-UE COT sharing should be allowed and in case how this should be enabled. In this sense, in one embodiment, one of the following options could be adopted:
Option 1—UE-to-UE is not allowed for CG transmission regardless of whether the cg-RetransmissionTimer is enabled or disabled.
Option 2—UE-to-UE is not allowed for CG transmission when the cg-RetransmissionTimer is disabled due to interpretation of the regulatory requirement, but UE-to-UE is allowed for CG transmission when the cg-RetransmissionTimer is enabled. In this case, this feature may be enabled or disabled through either UE-specific, cell-specific RRC configuration or activation DCI, or may be always enabled when operating in unlicensed spectrum.
Option 3—UE-to-UE is allowed in all cases. In this case, this feature may be enabled or disabled through either UE-specific, cell-specific RRC configuration or activation DCI, or may be always enabled when operating in unlicensed spectrum.

In one embodiment, when UE-to-UE is enabled, the UE will independently choose the LBT type to adopt and will determine by itself by decoding other SL transmissions when and how to apply CP extension before its own transmission when it is needed.

In one embodiment, For a UE to indicate whether its COT can be shared or not SCI (either stage 1 or stage 2 format or both or a single stage SCI) may be enhanced and it shall contain one of more of the following example information:
CAPC;
Indication on whether the current device is the initiating or responding device (this could be a single bit) and could be indicated for both dynamic and semi-static channel access mode or only for the second case;
Indication of remaining COT
   Granularity could be per slot or per symbol
   Indication could be via a combination of an RRC table and SCI field or SCI field only
      A specific indication can be reserved to indicate that the UE does not intend to share the COT (This could indicate type 0 sidelink COT sharing described in the following section)
   For semi-static channel access mode, the FFP configuration could be also shared
      Fixed frame period (FFP) length
      Offset value
Indication of the COT
   Duration of the COT, where the granularity could be per slot or per symbol
   Starting point of the COT, where the granularity could be per slot or per symbol
Destination ID, where this may be equivalent to the source ID for unicast transmission, or it may be the same as the destination ID in SCI for the groupcast and broadcast transmission(s).
Notice that these fields could be either added by refurbishing unused bits from fields that are no longer needed when operating in unlicensed band or could be added as a separate field. In any cases, it is important to note that there is no need to maintain the same payload with the SCI in licensed carrier, since through channelization a UE may be able to know whether it operates in licensed or unlicenced spectrum.

In this case, for UE's behavior refer to procedures/rules defined for mode 2, since same exact considerations could be applied here as well, while the behavior may be different or equal between mode 1 and mode 2.

The examples embodiments listed here are not mutually exclusive, and one or more of them may apply together.

### Additional Conditions for UE-to-UE COT Sharing in Mode 1

Regardless of the whether operating in mode 1-a, 1b, or 1c, when UE-to-UE COT sharing procedure is allowed and enabled, UE-initiated SL COT sharing information can be shared with all UEs in proximity range. However, in one embodiment, UE-to-UE COT sharing may target only a subset of destination UEs. In particular, one or more of the following types of SL COT sharing can be considered and enabled depending on the target set of destination UEs, or could be implicitly or explicitly enabled or indicated, or supported by default behavior:
Type 0 SL COT sharing (for SL transmissions from UE initiating a SL COT):
   With Type-0 COT sharing, a UE reserves some specific SL resources within a COT for its own transmissions only, which may be contiguous or not contiguous in time (i.e., there are pauses/gaps between transmissions within the COT).
Type-1 SL COT sharing (for response/feedback from destination UEs)
   Indication of Type-1 COT sharing can be used to request feedback/response from target destination UEs.
Type-2 SL COT sharing (for response/feedback and any SL transmissions by destination UEs)
   Type-2 COT sharing is used by destination UEs to provide response/feedback or any other SL transmissions.
Type 3 SL COT sharing (for all UEs in proximity)
   All UEs in neighborhood (proximity range) that have received SL COT information can access the SL channel as if they operate as responding devices.

While one or more of the above types could be adopted, some considerations should be made in terms of the CAPC and/or SL priority used by the initiating device. In one embodiment, if an initiating device acquires a COT using a given CAPC and/or SL priority, it can only share the COT with a responding device that intents to perform a transmission which is related to the same CAPC and/or SL priority or lower. In another embodiment, if an initiating device acquires a COT using a given CAPC and/or SL priority, it can only share the COT with a responding device that intents to perform a transmission which is related to the same CAPC and/or SL priority or higher.

### SL COT Sharing Procedure for Mode-2

### Conditions for Initiation of SL COT Sharing Transmission Outside of SL COT Sharing Interval

In one embodiment, a UE initiating SL COT sharing may need to satisfy one or more of the following example conditions:
The initiating device of SL COT sharing is able to
   succeed Type-1 (LBT Cat.4 procedure) when operating in dynamic channel access mode;
   succeed a single observation window of X us, where X=9 us except for China where X=16 us, before the start of the fixed frame period (FFP) associated to the initiating device when operating in semi-static channel access mode.
The initiating device of SL COT sharing has availability of data/control information for transmission and for the case of mode-1 operation, the gNB requests to initiate a SL COT.
   Operation w/Sidelink COT Sharing

To have a higher spectrum utilization and reduce overhead from LBT operation a SL COT acquired by a UE can be shared with one or multiple UEs in proximity range. In this matter, in one embodiment a UE may indicate within the SCI (Stage-1 or Stage-2 SCI format or both), one or more of the following information:
CAPC;
Indication on whether the current device is the initiating or responding device (this could be a single bit) and could be indicated for both dynamic and semi-static channel access mode or only for the second case;
Indication of remaining COT
   Granularity could be per slot or per symbol
   Indication could be via a combination of an RRC table and SCI field or SCI field only
      A specific indication can be reserved to indicate that the UE does not intend to share the COT (This could indicate type 0 sidelink COT sharing described in the following section)
   For semi-static channel access mode, the FFP configuration could be also shared
      Fixed frame period (FFP) length
      Offset value
Indication of the COT
   Duration of the COT, where the granularity could be per slot or per symbol
   Starting point of the COT, where the granularity could be per slot or per symbol
Destination ID, where this may be equivalent to the source ID for unicast transmission, or it may be the same as the destination ID in SCI for the groupcast and broadcast transmission(s).

### Retransmission of SL COT Sharing Information

In one embodiment, UEs can be (pre)-configured to support retransmission of SL COT sharing settings or information to improve reliability of SL COT sharing information delivery. In one embodiment, retransmission of SL COT information can be done by target destination UEs (e.g., group members) indicated for this specific COT or by all UEs in proximity, subject to availability of data/control for SL transmission and other pre-configuration settings (e.g., whether it is enabled, or SL-RSRP range). In one embodiment, UEs retransmitting the COT information are supposed to keep the same COT setting values, except for the values used to indicate the remaining time of the COT, if this is indicated (instead of initial COT duration and its start slot). In this regard, a few additional aspects should be also considered:

In one embodiment if a UE receives information from another UE that its transmission can fall within this UE's COT, the UE should assume on whether it will be operating as responding device or as an initiating device following one of the following options, which can be alternatively enabled by (pre-) configuration or by default behavior:
Option 1: A UE should always follow the indication from other UEs, and if it receives and assesses that its transmission will fall within another UE's SL COT, it shall operate as a responding device.
Option 2: It is left up to UE to decide and SL COT can be potentially extended based on the embodiments provided later in this disclosure.

In one embodiment, in the case when a UE (UE #2) whose transmission falls within another UE's COT (UE #1) fails to decode/receive the COT information from that UE (UE #1) and it starts initiating its own COT, it may occur that there could be a misunderstanding from a third UE (UE #3) hearing both on who will be the actual initiating device.
In this case, for dynamic channel access mode, UE #3 is expected to determine the actual initiating device from the COT sharing information of the other UEs assuming that UE #1 and UE #2 use the same CAPC/priority to acquire the COT. The actual initiating device can be determined by comparing remaining COT time or by considering UE #1 as initiating device. If UE #1 and UE #2 used different CAPC/SL priority, UE #3 should consider the UE with higher or lower priority as initiating device irrespective of remaining COT.
For semi-static channel access mode, similar considerations can be made with the difference that in this case the information regarding the remaining COT should be used in conjunction with the information related the length of the FFP and offset.

### Determination of SL COT Duration

In one embodiment, the determination of the actual COT duration (COT sharing interval) for SL communication may be dependent on one of more of the following example SL parameters used for SL resource selection subject to maximum COT duration limits:
Priority/CAPC of SL transmission for dynamic channel access mode and/or fixed frame period (FFP) parameters for semi-static channel access mode;
Packet delay budget (PDB);
Resource selection window (RSW) duration;
Intended number of (re)-transmissions (number of slots for TB/data transmission).

On the other hand, there may be no strong motivation to specify a UE's behavior for determination of COT duration and it can be left up to UE implementation to satisfy maximum COT duration limits that can be dependent on priority/CAPC for SL transmission. At least for dynamic channel access by configuration, a UE can be configured to bound SL COT duration by remaining PDB of the packet.

Behavior of UE that Initiated COT Sharing within COT Sharing Interval

Embodiments in this section may relate to the scenario when misdetection of the COT sharing information may occur among UEs, and a UE (UE #1) that initiated a COT later realizes than another UE (UE #2) has also initiated a COT.

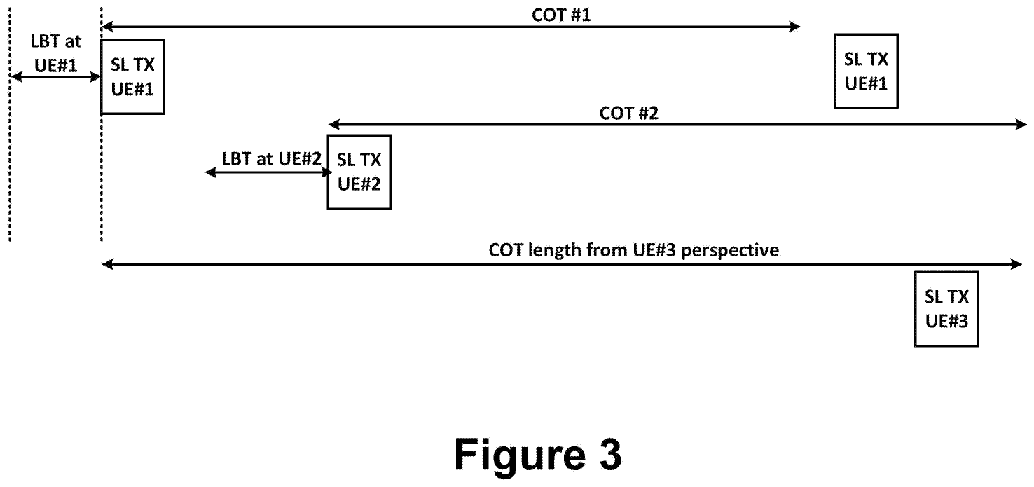

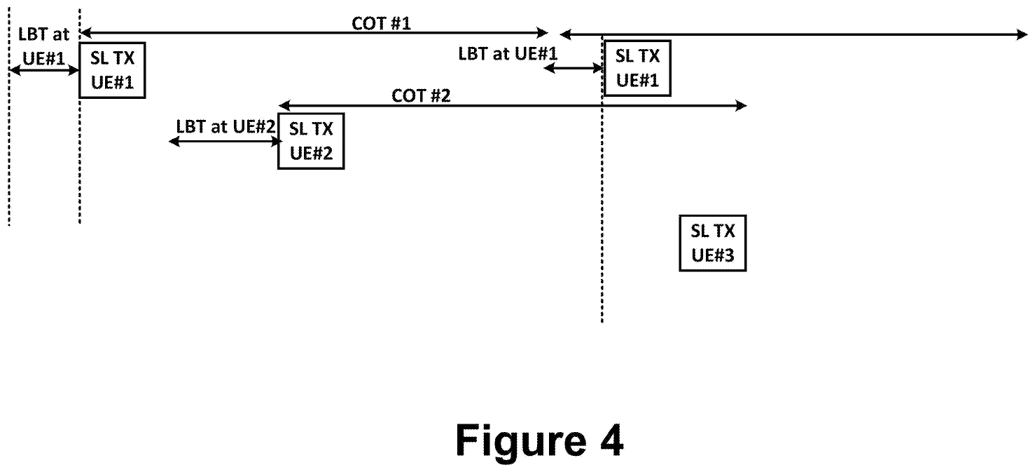

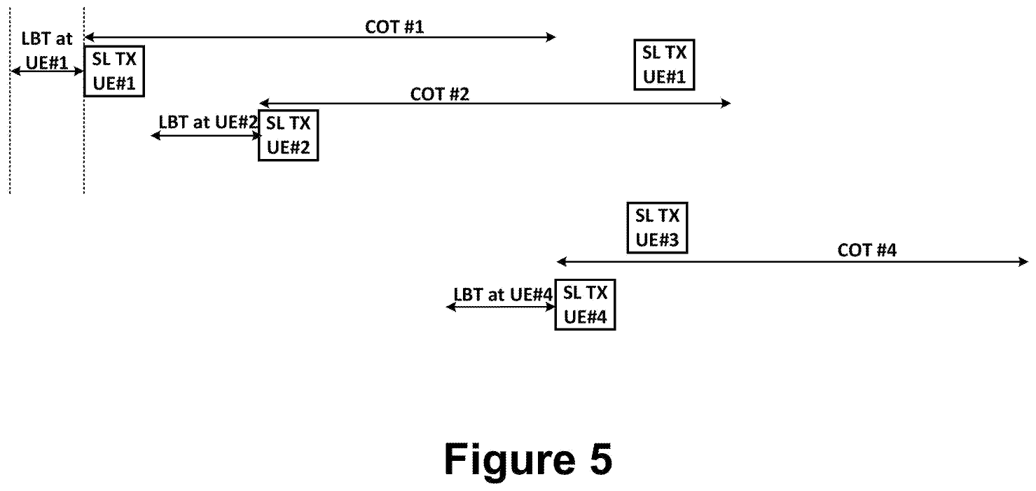

Scenario #1: In one embodiment, in the case when UE #1 initiates the COT earlier than UE #2, as illustrated in FIG. 3, the following cases may be considered, and the UE's behavior may follow one or more of the following example alternatives:
Case 1: (UE #1 transmission occurs within UE #1's COT interval)
   When UE #1 performs a transmission within UE #1's COT, it should indicate that it operates as an initiating device and provide updated COT sharing information and remaining COT, if this information is carried;
Case 2: (UE #1 transmission occurs within UE #2's COT interval which is outside of UE #1's COT)
   In one embodiment, when UE #1 performs a transmission within UE #2's COT but outside of UE #1's COT one of the following alternatives could be adopted:
      Alt. 1: (UE #1 operates as a COT responder)
         The UE #1 assesses that it should operate as a responding device (this will lead to prolongation of MCOT as described later in this disclosure);
      Alt. 2: (UE #1 operates as a COT initiator or responder)
         If UE #1 has not received any information from other UEs (e.g., UE #3) rather than UE #2, that they operate as initiating device, it assumes that it should operate as an initiating device as illustrated in FIG. 4. Otherwise, it should operate as responding device and when providing the COT sharing information it should update this information base on the remaining COT information provided by UE #3, and consider this UE as the actual initiating device as illustrated in FIG. 5.

Scenario #2: In one embodiment, in the case when UE #2 initiates the COT earlier than UE #1, the following cases may be considered and the UE's behavior may follow one or more of the following example alternatives:
Case 1: Regardless of whether the transmission from UE #1 falls within or without UE #1's, if the transmission falls within UE #2's COT,
   Alt 1: UE #1 will assess that UE #2 is the initiating device;
   Alt 2: UE #1 will assess that it shall still operate as the initiating device.
Case 2: The transmission falls outside of UE #2's COT:
   Alt1: The UE #1 assesses that it should operate as initiating device;
   Alt2: If UE #1 has not received any information from other UEs (e.g., UE #3) rather than UE #2, that they operate as initiating device, it assumes that it should operate as an initiating device. Otherwise, it should operate as responding device if the UE #3 COT has initiated earlier.

### Conditions for SL COT Sharing Initiation Inside of SL COT Sharing Interval

In one embodiment, when a UE falls within a COT sharing interval of another UE, one or more of the following example options may be adopted:
Option 1: SL COT sharing inside of a SL COT sharing interval is not supported by default, and a UE operating as responding device, cannot initiate its own COT within another UE's COT.
Option 2: SL COT sharing inside of a SL COT sharing interval is supported by pre-configuration (i.e., can be enabled or disabled) or predefined as a default behavior, and one or more of the following could be adopted:
   If SL COT sharing inside of a SL COT sharing interval is enabled or supported by a UE, a new SL COT sharing can be initiated at least subject to success of Type-1 LBT procedure within current SL COT sharing interval. Furthermore, in one embodiment the MCOT should be selected based on one of the following alternatives:
      Alt 1: the COT cannot be extended and cannot exceed the MCOT of the first UE that initiated the first COT;
      Alt 2: the COT can be extended as concatenation of MCOTs.
   If SL COT sharing inside of a SL COT sharing interval is enabled or supported by a UE, a new SL COT sharing can be initiated subject on success of Type-2A/2B LBT.

### Additional Conditions for UE-to-UE COT Sharing in Mode 2

When UE-to-UE COT sharing procedure is allowed and enabled for mode 2, UE-initiated SL COT sharing information may be shared with all UEs in proximity range. However, in one embodiment, UE-to-UE COT sharing may target only a subset of destination UEs. In particular, one or more of the following types of SL COT sharing can be considered and enabled depending on the target set of destination UEs, or could be implicitly or explicitly enabled or indicated, or supported by default behavior:
Type 0 SL COT sharing (for SL transmissions from UE initiating a SL COT)
   With Type-0 COT sharing, a UE reserves some specific SL resources within a COT for its own transmissions only, which may be contiguous or not contiguous in time (i.e., there are pauses/gaps between transmissions within the COT).
Type-1 SL COT sharing (for response/feedback from destination UEs):
   Indication of Type-1 COT sharing can be used to request feedback/response from target destination UEs.
Type-2 SL COT sharing (for response/feedback and any SL transmissions by destination UEs)
   Type-2 COT sharing is used by destination UEs to provide response/feedback or any other SL transmissions.
Type 3 SL COT sharing (for all UEs in proximity)
   All UEs in neighborhood (proximity range) that have received SL COT information can access the SL channel as if they operate as responding devices.

While one or more of the above types could be adopted, some considerations should be made in terms of the CAPC and/or SL priority used by the initiating device. In one embodiment, if an initiating device acquires a COT using a given CAPC and/or SL priority, it can only share the COT with a responding device that intents to perform a transmission which is related to the same CAPC and/or SL priority or lower. In another embodiment, if an initiating device acquires a COT using a given CAPC and/or SL priority, it can only share the COT with a responding device that intents to perform a transmission which is related to the same CAPC and/or SL priority or higher.

### SL COT Sharing Based on Frequency Resource Utilization of the Initiating UE

In one embodiment, a UE may be able to share/utilize the SL COT acquired by another UE if its frequency resources are the same or a subset of those used by the initiating device. In this case, one or more of the following examples may be applied:
If the responding device is required an LBT procedure, the ED threshold that the responding device will use is not adjusted based on its frequency resource utilization.
If the responding device is required an LBT procedure, the ED threshold that the responding device will use is adjusted based on its frequency resource utilization.

In one embodiment, a UE may be able to share/utilize the SL COT acquired by another UE independently of the frequency resources used by the initiating device.

### UE's Request for Initiation of SL COT Sharing by Another UE(s)

In SL, in one embodiment, a UE (e.g., UE #1) can request another UE (e.g., UE #2) to initiate SL COT sharing. This may be beneficial in case of unicast or groupcast communication, or for semi-static channel access mode, when a UE may not be able to acquire its own FFP. Also, one of the possible use cases may be when a UE that is the actual initiating device would like to release its COT, and allow another device to operate as an initiating device even if the MCOT for that device has not yet terminated. In this case, in one embodiment, one or more of the following example options could be adopted:
Option 1: An additional field could be carried in the SCI (Stage-1 or Stage-2 SCI formats or both), which indicates that the UE #1 would either like to release its COT if the transmission still belongs within its initial COT, or that despite of who is currently the initiating device, UE #1 would like to operate as responding device.
Option 2: When a field indicating whether a device operate as initiating or responding device and/or the remaining COT information is carried within the SCI (Stage-1 or Stage-2 SCI formats or both), these may be used to release the COT according to one or more of the following alternatives:
   Alt. 1: Given a UE (e.g., UE #1) operating as an initiating device that acquired a COT, when it intends to release it, it may indicate within its SL COT information that the remaining COT is 0, which may be interpreted by other devices as if that UE #1's COT has terminated, and that UE is requesting another UE to acquire the COT;
   Alt. 2: Given a UE (e.g., UE #1) operating as an initiating device that acquired a COT, when it intends to release it, it may indicate within its SL COT information that it operates as a responding device, which may be interpreted by other devices as if that UE #1's COT has terminated, and that UE is requesting another UE to acquire the COT;
   Alt. 3: Given a UE (e.g., UE #1) operating as an initiating device that acquired a COT, when it intends to release it, it may indicate within its SL COT information that it operates as a responding device, and jointly that the remaining COT is 0: this may be interpreted by other UEs as if that UE #1's COT has terminated, and that UE is requesting another device to acquire the COT.

### Prolongation or Extension of SL COT Sharing Interval

Extension of the SL COT sharing interval can be beneficial if a UE has received additional packet for SL transmission during an ongoing SL COT sharing interval, and also from spectrum utilization point of view. In this matter, in one embodiment one or more of the following example options may be adopted:
Option 1: In one option an initiating UE prolongs/extends its SL COT sharing interval by updating the information related to the remaining COT length indicated within the SCI (Stage-1 or Stage-2 SCI formats or both). In one embodiment, the extension could be performed up to the MCOT which is either pre-configuration or based on CAPC/PPPP used. In another embodiment, the extension could be applied pass the MCOT which is either pre-configuration or based on CAPC/PPPP used. In one embodiment, when an initiating UE extends its COT, and operates in dynamic channel access mode, it is not required a Type-1 LBT procedure to perform COT extension, but a shorted sensing could be applied, and the specific LBT type (type 2A, 2B or 2C) is used based on the gap between the latest prior transmission burst performed within the initiating device's COT and the new UL burst that the initiating device intends to perform.
Option 2: In one option, a responding device operating within another UE's COT, may be able to prolongs/extends that UE's SL COT sharing interval by updating the information related to the remaining COT length indicated within its SCI (Stage-1 or Stage-2 SCI formats or both). In one embodiment, the extension could be performed up to the MCOT of the initiating device which is either pre-configuration or based on CAPC/PPPP used. In another embodiment, the extension could be applied pass the MCOT of the initiating device which is either pre-configuration or based on CAPC/PPPP used. In one embodiment, when a responding UE extends the COT of an initiating UE, and it operates in dynamic channel access mode, it is not required a Type-1 LBT procedure to perform COT extension, but a shorted sensing could be applied, and the specific LBT type (type 2A, 2B or 2C) is used based on the gap between the latest prior transmission burst performed within the initiating device's COT and the new UL burst that the responding device intends to perform.

### Sidelink COT Propagation and Yielding Procedure Based on SL Priority/CAPC Information

In one embodiment, one or more of the following example options may be adopted:
Option 1—When a UE receives SL COT information from multiple different UEs, which indicate that multiple UEs have initiated a COT, that UE is expected to follow the SL COT associated with the equal or higher SL priority/CAPC. Such behavior is also applicable to UEs that have initiated their own COTs and then received COT with the equal or higher SL priority/CAPC.
Option 2—When a UE receives SL COT information from multiple different UEs, which indicate that multiple UEs have initiated a COT, that UE is expected to follow the SL COT associated with the equal or higher SL priority/CAPC. In case, multiple UEs may have initiated a SL COT with the same CAPC, the SL COT associated to the UE that initiated the COT first is chosen. Such behavior is also applicable to UEs that have initiated their own COTs and then received COT with the equal or higher SL priority/CAPC.
Option 3—When a UE receives SL COT information from multiple different UEs, which indicate that multiple UEs have initiated a COT, that UE is expected to follow the SL COT associated with the equal or lower SL priority/CAPC. Such behavior is also applicable to UEs that have initiated their own COTs and then received COT with the equal or lower SL priority/CAPC.
Option 4—When a UE receives SL COT information from multiple different UEs, which indicate that multiple UEs have initiated a COT, that UE is expected to follow the SL COT associated with the equal or lower SL priority/CAPC. In case, multiple UEs may have initiated a SL COT with the same CAPC, the SL COT associated to the UE that initiated the COT first is chosen. Such behavior is also applicable to UEs that have initiated their own COTs and then received COT with the equal or lower SL priority/CAPC.
   Behavior of Responding UEs within a COT Sharing Interval

In one embodiment, a responding UE operating within another UE's COT sharing interval may follow one or more of the following:
Perform SL transmission of HARQ ACK/NACK on physical sidelink feedback channel (PSFCH) or PUCCH resources according to configuration of resource pool slot structure subject to LBT operation and request from TX UEs;
Perform SL transmission of SL block acknowledgements subject to LBT operation and request from TX UEs;
Perform SL transmission on assigned/scheduled resources within the COT sharing interval subject to request from the COT sharing initiator;
Perform SL transmissions to other UEs within the shared COT interval;
Perform retransmission of sidelink COT sharing (remaining COT sharing) information, which may be updated according to the aforementioned rules.
   Special Considerations for Sharing the COT with PSFCH

In one embodiment, regardless on whether the system operates in mode 1 or mode 2, when a TX UE shares its COT with the intent to allow a RX UE to transmit back the PSFCH, the SCI (either stage 1 or stage 2 or both) could be enhanced to contain one or more of the following information:
CP extension that the RX UE shall apply before transmitting the PSFCH
Type of LBT to use

### Redundancy Indication of the COT Sharing Information

Regardless on whether the system operates in mode 1 or mode 2, if an initiating device is allowed to share its COT with other UEs, whether the COT can be utilized by the intended responding UEs may depend on whether the COT sharing information (e.g., whether the COT can be shared, unused resources, etc.) is successfully received and decoded in a timely manner by these UEs. In some cases, the processing time may not be sufficient for a UE to decode that information in a timely manner to be able to serve as a responding device, or an intended responding UE may miss that information. In these scenario the intended responding UEs may not be able to utilize the unused COT, which otherwise could have been utilized. In order to mitigate this issue, in one embodiment, a responding UE that is able to decode the COT sharing information from an initiating device, when transmitting as a responding device within the initiating device's COT may carry in the SCI (either 1st stage or 2nd stage or both) the updated version of the COT sharing information, which may contain one or more of the following example fields/information:
CAPC initially indicated by the initiating device;
Indication that the current device is the responding device and could be indicated for both dynamic and semi-static channel access mode or only for the second case;
indication of remaining COT or an updated version based on the resources utilized by the responding device:
   Granularity could be per slot or per symbol
   Indication could be via a combination of an RRC table and SCI field or SCI field only
      A specific indication can be reserved to indicate that the UE does not intend to share the COT (This could indicate type 0 sidelink COT sharing described in the following section)
   For semi-static channel access mode, the FFP configuration could be instead shared
      Fixed frame period (FFP) length
      Offset value
Destination ID, where this may be equivalent to the source ID for unicast transmission, or it may be the same as the destination ID in SCI for the groupcast and broadcast transmission(s).
Indication of the COT or an updated version based on the resources utilized by the responding device:
   Duration of the COT, where the granularity could be per slot or per symbol
   Starting point of the COT, where the granularity could be per slot or per symbol
   In various embodiments, these fields could be either added by refurbishing unused bits from fields that are no longer needed when operating in unlicensed band, or could be added as a separate field. In any cases, it is important to note that there is no need to maintain the same payload with the SCI in licensed carrier, since through channelization a UE may be able to know whether it operates in licensed or unlicensed spectrum.

### Restrictions for Sharing the COT

In one embodiment, regardless on whether the system operates in mode 1 or mode 2, COT sharing may be only allowed for unicast transmissions: e.g., a UE is allowed to share its COT only with a UE or UEs from which it expects HARQ-ACK feedback information or control channel information. In this regard, the responding devices for a specific COT are only allowed to use the share COT for the purpose of transmitting specific information/channels, such as PFSCH and/or control information and/or HARQ-ACK feedback information, while they will be required to acquire their own COT to transmit any other type of information.

In one embodiment, regardless on whether the system operates in mode 1 or mode 2, COT sharing may be only allowed for unicast and group-cast transmissions: e.g., a UE is allowed to share its COT only with a UE or group of UEs from which it expects HARQ-ACK feedback information or control channel information or data transmission.

In another embodiment, regardless on whether the system operates in mode 1 or mode 2, COT sharing may be only allowed for unicast and group-cast transmissions and broadcast information: e.g. a UE is allowed to share its COT only with a UE or group of UEs from which it expects HARQ-ACK feedback information or control channel information or data transmission. In addition, if any of these devices also transmits broadcast information this is also allowed as part of the COT sharing.

In one embodiment, regardless on whether the system operates in mode 1 or mode 2, COT sharing may allow an initiating device to resume transmission within a COT by performing any of the type 2 LBT procedure defined in Rel. 16 NR-U based on the gap between the new transmission burst and the latest transmission burst from the initiating device or as an alternative from any other device.

It will be understood that the example embodiments listed here are not mutually exclusive, and one or more of them may apply together.

### Length of the COT

When operating in dynamic channel access mode, one or more of the following example options could be adopted:
In one option, any UE, whether operating as initiating or responding device, will be associated to the UL CAPC table defined in TS 37.213 and indicated below in Table V:

TABLE V
Example Channel Access Priority Class (CAPC) for UL

| Channel | | | | | |
|---|---|---|---|---|---|
| Access | | | | | |
| Priority Class | | | | | |
| (p) | mₚ | cw_{min, p} | cw_{max, p} | T_{ulm cot, p} | allowed cwₚsizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

NOTE1:
For p = 3, 4, T_{ulm, cot, p} = 10 ms if the higher layer parameter absenseOfAnyOtherTechnology-r14 or absence OfAnyOtherTechnology-r16 is provided, otherwise, T_{ulm, cot, p} = 6 ms.
NOTE2:
When T_{ulm, cot, p} = 6 ms it may be increased to 8 ms by inserting one or more gaps. The minimum duration of a gap shall be 100 us. The maximum duration before including any such gap shall be 6 ms.

This means that a UE may assume the length of the COT may correspond to that in Table V depending on the CAPC priority class used, which may be indicated within the SCI of the initiating device. Also when performing type 1 LBT, the minimum contention window (CWmin) and maximum contention window (CWmax) indicated in Table V as well as the allowed contention window for a given priority class, p (CWp) indicated within the same table are re-used.
In one option, any UE, whether operating as initiating or responding device, will be associated to the DL CAPC table defined in TS 37.213 and indicated below in Table VI:

TABLE VI
Example Channel Access Priority Class (CAPC) for DL

| Channel | | | | | |
|---|---|---|---|---|---|
| Access | | | | | |
| Priority Class | | | | | |
| (p) | mₚ | cw_{min, p} | cw_{max, p} | T_{ulm cot, p} | allowed cwₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

This means that a UE may assume the length of the COT may correspond to that in Table VI depending on the CAPC priority class used, which may be indicated within the SCI of the initiating device. Furthermore, in this case for p=3, 4, T_{ulm cot, p}=10 ms if the higher layer parameter absenceOfAnyOtherTechnology-r14 or absenceOfAnyOtherTechnology-r16 is provided, otherwise, T_{ulm cot,p}=8 ms. Also, when performing type 1 LBT, the CWmin and CWmax indicated in Table VI as well as the allowed CWp indicated within the same table are re-used.
In one option, a UE responding device may be associated to the UL CAPC table defined in TS 37.213 and indicated above in Table V, while a responding device may be associated to the DL CAPC table defined in TS 37.213 and indicated above in Table VI, or vice-versa.
In one option, a gNB may configure the CAPC table to be used via higher layers through remaining minimum system information (RMSI) or dedicated radio resource control (RRC) signalling and this information may indicate the CAPC table to be used either by all UEs or by only initiating device or by only responding devices. As an alternative, two separate higher layer information could be introduced, where one indicates the CAPC table to be used by the initiating devices, and the other one indicated the CAPC table to be used by the responding devices.
In one option, it is left up to a UE to choose which CAPC table to use.
In one option, a UE may indicate within SCI (either 1^{st} stage or 2^{nd} stage or both) the CAPC table that is used via a new field, which if configured to ‘0’ may indicate that the UL CAPC table summarized in Table V is used, while if configured to ‘1’ may indicate that the DL CAPC table summarized in Table VI is used, or viceversa.
In one option, whether a UE may follow the UL or DL CAPC table may depend on the resource allocation mode in which that UE is operating in. For instance, when a UE operates in RA mode 1 then it follows the UL CAPC, while when the UE operates in RA mode 2 then it follows the DL CAPC.
In one option, whether a UE may follow the UL or DL CAPC table is configured by the gNB/network or pre-configured in either a UE specific or cell-specific mode.

It will be understood that the above-described embodiments are not mutually exclusive, and one or more of them may apply together.

### Additional Exemptions

In one embodiment, if LBT may be needed by a UE to transmit PSFCH outside a COT, a UE may use the lowest priority class (p=1), and may not be able to share the acquired COT with no other UEs.

In one embodiment, if LBT may be needed by a UE to transmit PSFCH outside a COT, a UE may use the lowest priority class (p=1), and may be able to share the acquired COT with other UEs according to the rules and restrictions indicated along this disclosure.

In one embodiment, if LBT may be needed by a UE to transmit S-SSB, a UE may use the lowest priority class (p=1), and may not be able to share the acquired COT with no other UEs.

In one embodiment, if LBT may be needed by a UE to transmit S-SSB, a UE may use the lowest priority class (p=1), and may be able to share the acquired COT with other UEs according to the rules and restrictions indicated along this disclosure.

### Mechanisms to Handle Misdetection of PDCCH in Mode 1a

In one embodiment, under mode 1a, if a UE which is scheduled to operate as an initiating device may miss the corresponding PDCCH carry the scheduling DCI, while the gNB may be unaware of this event and think that the UE has initiated the COT, the UE will not even be performing the LBT and transmitting, and therefore acquiring the COT. In this sense, any subsequent transmissions from that UE or any other UEs which were intended to be transmitted within a shared COT, could be still occur but under a different channel access procedure. In this matter, in one embodiment, a UE indicated to operate as a responding device could perform its transmission only after assessing that the corresponding COT has been initiated, which could be retrieved through one or more of the following example options:
the gNB indicates within the scheduling DCI, the initiating device ID, which is used by the responding device to determine whether the initiating device has indeed acquired the COT.
the responding device receives a PSSCH/PSCCH from the initiating device, which explicitly indicates that the COT has been acquired via an additional field indicated within the SCI (either first stage or second stage or both).

In one embodiment, if the responding device is not able to retrieve information on whether the initiating device has acquired or not the COT, one or more of the following example options could be adopted:
the responding device drops the intended transmissions.
the responding device attempts to transmit the intended UL transmission by acquiring its own COT, and if that UE later on will realize that the COT has indeed been acquired by the original initiating device, it will drop the COT and indicate within the SCI of any additional SL transmission within that COT that it operates as responding device.
the responding device attempts to transmit the intended UL transmission by acquiring its own COT, and if that UE later on will realize that the COT has indeed been acquired by the original initiating device, it will maintain its own COT, and it will indicate within the SCI of any additional SL transmissions within its own COT that it operates as initiating device.

### COT Sharing Information Transmission and Acknowledgement of Reception

In one embodiment, for mode 1 the COT sharing information discussed above is transmitted to the UE initiating the COT as well as other UEs also transmitting in the same COT via downlink (DL) medium access control (MAC) control element (CE) signaling or some other higher-layer signaling. As the MAC CE is part of the shared channel transmissions, hybrid automatic repeat request (HARQ) feedback is enabled, thus the gNB may know if the information was correctly received or not.

In one embodiment, for mode 1 the COT sharing information discussed above is transmitted to the UE initiating the COT as well as other UEs also transmitting in the same COT DCI control information inside the physical downlink control channel (PDCCH). Usually, a gNB cannot directly tell if the DCI information was correctly received. As this has a higher importance for COT sharing related information, HARQ feedback or a handshaking procedure using the uplink control information (UCI) in the physical uplink shared channel (PUSCH) or the physical uplink control channel (PUCCH) can be used for this purpose.

In one embodiment, for mode 2 the COT sharing information discussed above is shared via SL MAC CE signaling. As the SL MAC CE is transported via the SL shared channel the transmitting device knows via the HARQ feedback if the information was correctly received. Thus, the devices transmitting this information know if it was correctly received and can respond accordingly.

In another embodiment, for mode 2 the COT sharing information discussed above is shared via SCI signaling. Usually, a UE cannot directly tell if the SCI information was correctly received. As this has a higher importance for COT sharing related information, it is possible that the intended recipient of the SCI is giving HARQ feedback for this SCI either inside the PSFCH, MAC CE signaling, or as part of the SCI.

gNB's Aided COT Sharing

As discussed herein, when operating in mode 1 there may be multiple interpretation on the gNB's behavior and whether the gNB may or may not be able to perform sensing in the SL unlicensed spectrum. In case sensing by the gNB is not allowed/supported in the SL unlicensed spectrum, but the gNB is still expected to operate as a coordinator in the unlicensed spectrum among the UEs by providing them for instance information on whether they should operate as initiating or responding devices or what LBT type to use or CPE to apply. In this case, it may be necessary to allow UEs operating in unlicensed spectrum to indicate back to the gNB information related to their COT. In this case, in one embodiment, one or more of the reserved indices (i.e., 35-44) or octet(s) of the indices of the UL MAC CE may be utilized for this scope and for instance may be used for one or more of the following example use cases:
indicate whether the UE has been able to acquire or not a COT when performing SL transmissions on unlicensed spectrum.
indicate whether it may be operating as initiating or responding device.
indicate the type of LBT used to acquire a COT or in general to perform a SL transmission

In one embodiment, the above information may be relative to the prior scheduled UL transmission which the UE may have performed in unlicensed spectrum or may be relative to an UL transmission which the UE may have performed in a prior instance of time and it is not necessarily related to the prior UL transmission performed in unlicensed spectrum, and may have occurred at least or at most m symbols/slots or transmissions where m can be fixed or configurable and indicated by higher layer signaling.

### Systems and Implementations

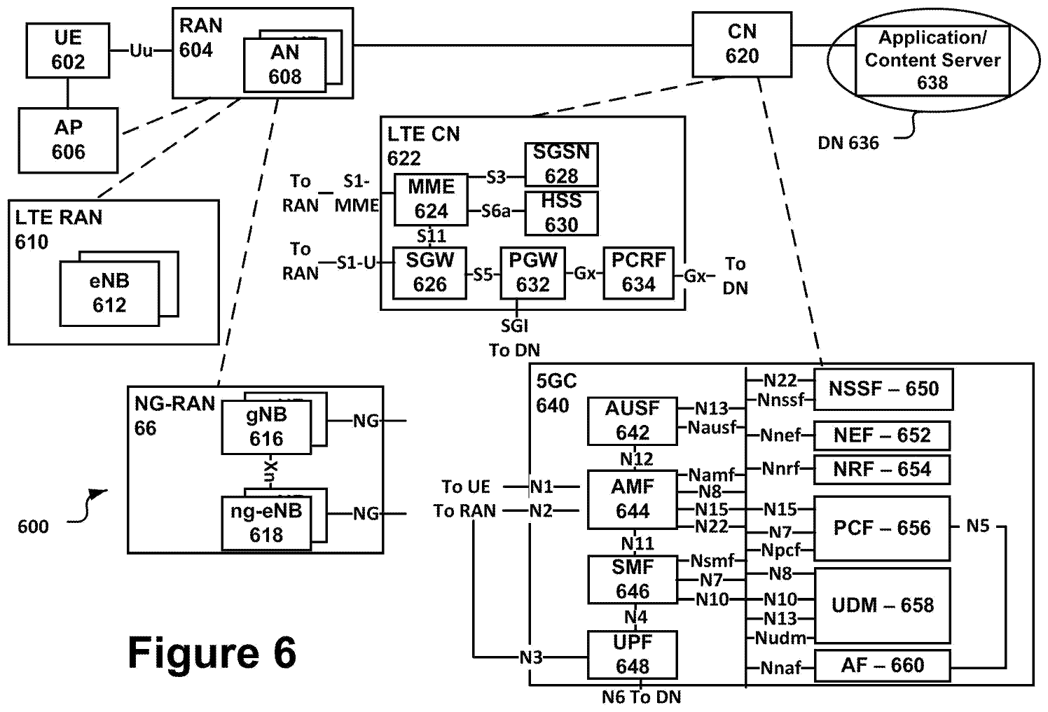

FIGS. 6-9 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an SI interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 6 36 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3rd party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

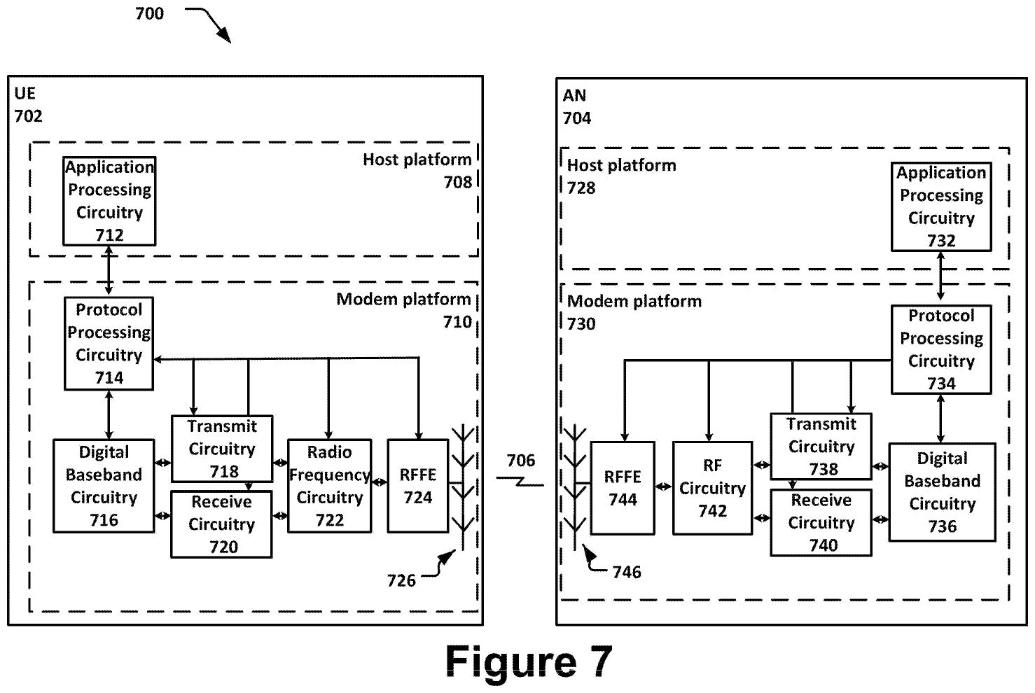

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mm Wave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

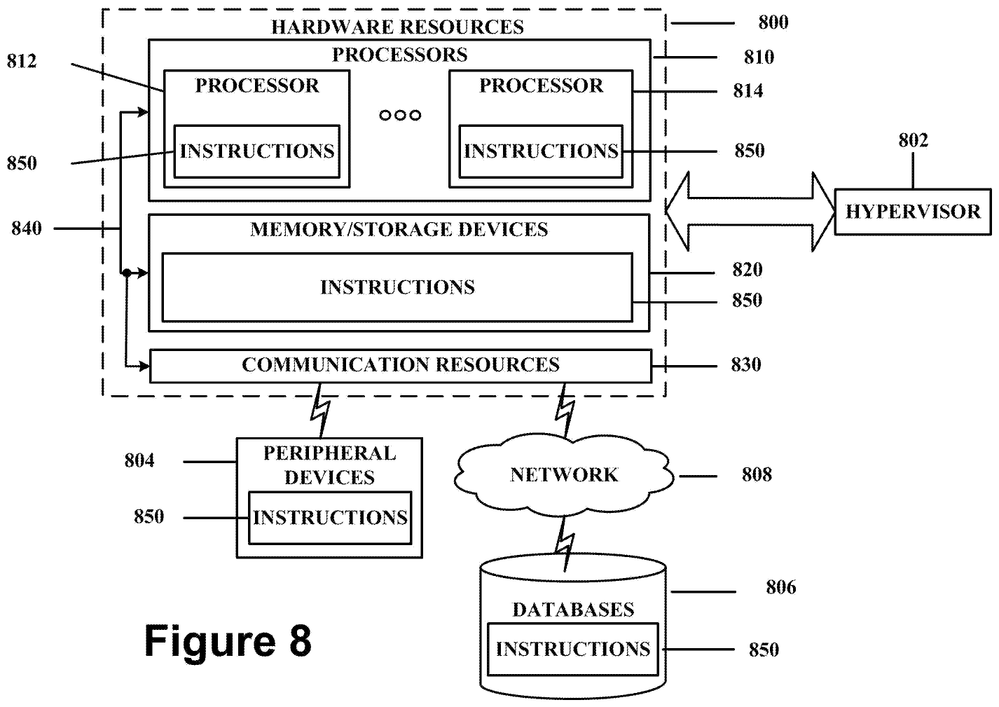

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

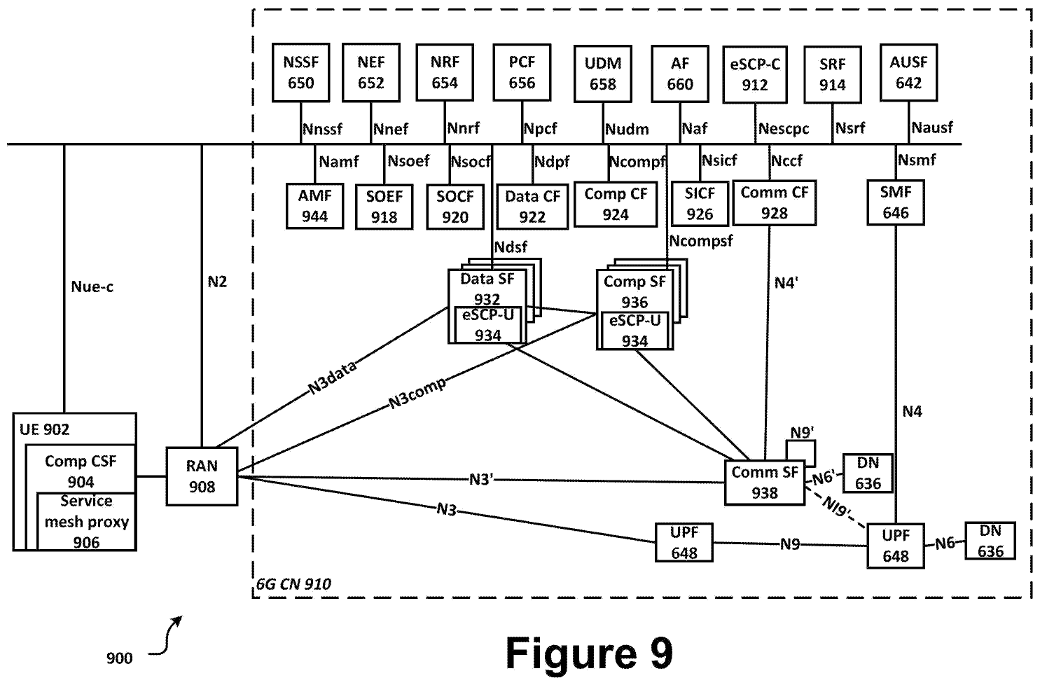

FIG. 9 illustrates a network 900 in accordance with various embodiments. The network 900 may operate in a matter consistent with 3GPP technical specifications or technical reports for 6G systems. In some embodiments, the network 900 may operate concurrently with network 600. For example, in some embodiments, the network 900 may share one or more frequency or bandwidth resources with network 600. As one specific example, a UE (e.g., UE 902) may be configured to operate in both network 900 and network 600. Such configuration may be based on a UE including circuitry configured for communication with frequency and bandwidth resources of both networks 600 and 900. In general, several elements of network 900 may share one or more characteristics with elements of network 600. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 602. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 606 as described with respect to FIG. 6. Additionally, although not specifically shown in FIG. 9, in some embodiments the RAN 908 may include one or more ANss such as AN 608 as described with respect to FIG. 6. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 650, NEF 652, NRF 654, PCF 656, UDM 658, AF 660, SMF 646, and AUSF 642. The 6G CN 910 may additional include UPF 648 and DN 636 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlaying computing infrastructure for computing resource management, etc., Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 646 and UPF 648, which were described with respect to a 5G system in FIG. 6. The upgrades provided by the Comm CF 928 and the Comm SF 938 may enable service-aware transport. For legacy (e.g., 4G or 5G) data transport, SMF 646 and UPF 648 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 654, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 644, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

### Example Procedures

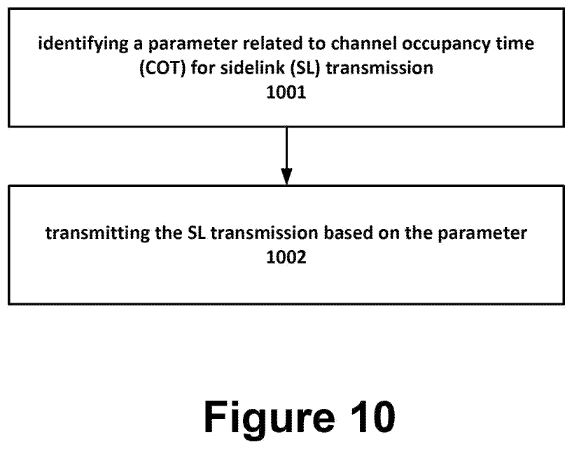

In some embodiments, the electronic device(s), network(s), system(s), chip(s) or component(s), or portions or implementations thereof, of FIGS. 6-9, or some other figure herein, may be configured to perform one or more processes, techniques, or methods as described herein, or portions thereof. One such process is depicted in FIG. 10. The process may relate to a method to be performed by a user equipment (UE), one or more elements of a UE, or an electronic device that includes a UE. The process may include identifying, at 1001, a parameter related to channel occupancy time (COT) for sidelink (SL) transmission; and transmitting, at 1002, the SL transmission based on the parameter.

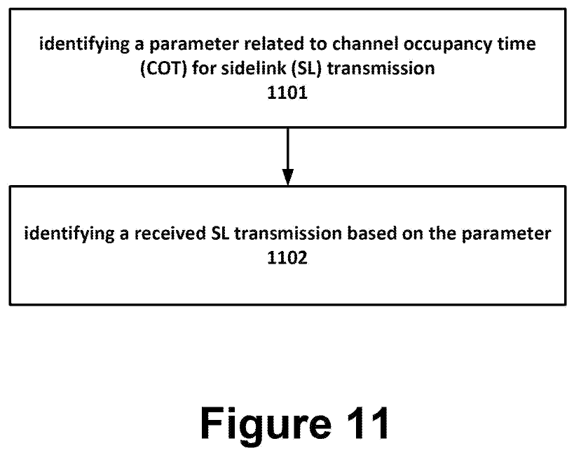

Another such process is depicted in FIG. 11. The process may relate to a method to be performed by a user equipment (UE), one or more elements of a UE, or an electronic device that includes a UE. The process may include identifying, at 1101, a parameter related to channel occupancy time (COT) for sidelink (SL) transmission; and identifying, at 1102, a received SL transmission based on the parameter.

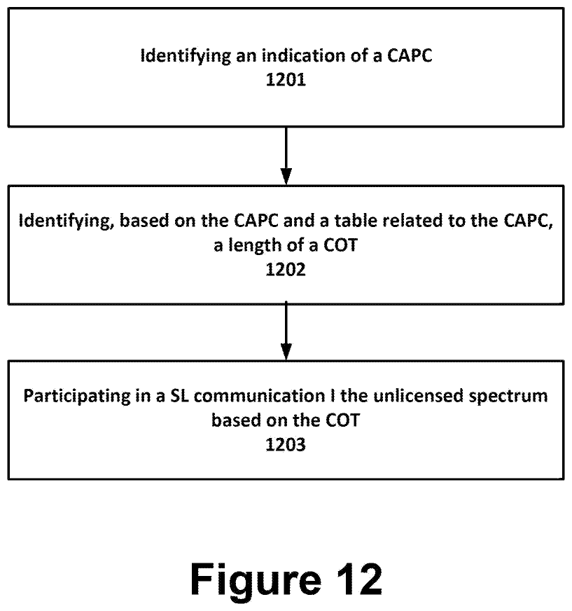

Another such process is depicted in FIG. 12. The process of FIG. 12 may relate to a method to be performed by a user equipment (UE), one or more elements of a UE, and/or one or more electronic devices that include and/or implement a UE. The process may include identifying, at 1201, an indication of a channel access priority class (CAPC); identifying, at 1202 based on the CAPC and a table related to the CAPC, a length of a channel occupancy time (COT); and participating, at 1203, in a sidelink (SL) communication in the unlicensed spectrum based on the COT.

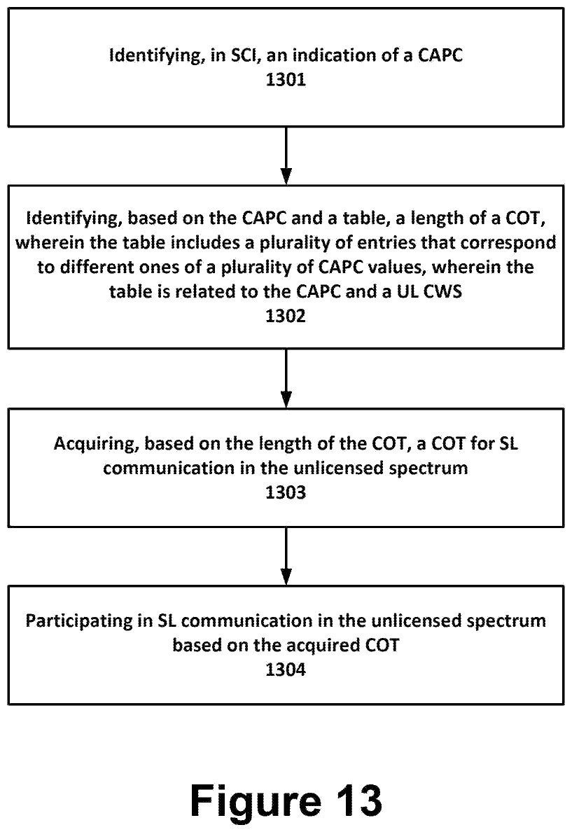

Another such process is depicted in FIG. 13. The process of FIG. 13 may relate to a method to be performed by a user equipment (UE), one or more elements of a UE, and/or one or more electronic devices that include and/or implement a UE. The process may include identifying, at 1301 in sidelink (SL) control information (SCI), an indication of a channel access priority class (CAPC); identifying, at 1302 based on the CAPC and a table, a length of a channel occupancy time (COT), wherein the table includes a plurality of entries that correspond to different ones of a plurality of CAPC values, wherein the table is related to the CAPC and an uplink (UL) contention window size (CWS); acquiring, at 1303 based on the length of the COT, a COT for SL communication in the unlicensed spectrum; and participating, at 1304, in SL communication in the unlicensed spectrum based on the acquired COT.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the methods and procedures on how to enable COT sharing in an unlicensed band with the gNB acting as a scheduling, coordination and/or initiating device

Example 2 may include the methods and procedures where COT sharing for the SL across different UEs is instantiated by UE based on network instructions

Example 3 may include the methods and procedures where COT sharing for the SL across different UEs is instantiated by a UE based on its own considerations

Example 4 may include the methods and procedures where UEs are responding to the initiated COTs

Example 5 may include the methods and procedures for sharing a COT with UE transmitting PSFCH.

Example 6 includes a method to be performed by a user equipment (UE), one or more elements of a UE, or an electronic device that includes a UE, wherein the method comprises:
identifying a parameter related to channel occupancy time (COT) for sidelink (SL) transmission; and
transmitting the SL transmission based on the parameter.

Example 7 includes the method of example 6 and/or some other example herein, wherein the COT is related to SL transmission in an unlicensed band.

Example 8 includes the method of any of examples 6-7, and/or some other example herein, wherein the parameter is predefined.

Example 9 includes the method of any of examples 6-8, and/or some other example herein, wherein the parameter is indicated by a fifth generation (5G) nodeB (gNB).

Example 10 includes the method of any of examples 6-9, and/or some other example herein, wherein the parameter is based on identification of a SL mode of operation of the UE.

Example 11 includes a method to be performed by a user equipment (UE), one or more elements of a UE, or an electronic device that includes a UE, wherein the method comprises:
identifying a parameter related to channel occupancy time (COT) for sidelink (SL) transmission; and
identifying a received SL transmission based on the parameter.

Example 12 includes the method of example 11 and/or some other example herein, wherein the COT is related to SL transmission in an unlicensed band.

Example 13 includes the method of any of examples 11-12, and/or some other example herein, wherein the parameter is predefined.

Example 14 includes the method of any of examples 11-13, and/or some other example herein, wherein the parameter is indicated by a fifth generation (5G) nodeB (gNB).

Example 15 includes the method of any of examples 11-14, and/or some other example herein, wherein the parameter is based on identification of a SL mode of operation of the UE.

Example 16 includes the method of any of examples 6-15, and/or some other example herein, wherein the COT parameter is based on whether the SL transmission is unicast, group-cast, or broadcast.

Example 17 includes the method of any of examples 6-16, and/or some other example herein, wherein the COT parameter is related to a Type 2 listen-before-talk (LBT) procedure.

Example 18 includes the method of any of examples 6-17, and/or some other example herein further comprising transmitting, from a UE that received the SL transmission to a UE that transmitted the SL transmission, updated COT sharing information within sidelink control information (SCI).

Example 19 includes the method of any of examples 6-18, and/or some other example herein, wherein sidelink control information (SCI) includes one or more of CAPC, an indication of whether the device is initiating o responding indication of remaining COT, FFP configuration, indication of the COT, and/or destination ID.

Example 20 includes the method of any of examples 6-19, and/or some other example herein, wherein the gNB operates as a coordinator for the SL transmission and receives information from a UE in a UL MAC CE.

Example 21 may include a method to be performed by a user equipment (UE), one or more elements of a UE, and/or one or more electronic devices that include and/or implement a UE, wherein the method comprises: identifying an indication of a channel access priority class (CAPC); identifying, based on the CAPC and a table related to the CAPC, a length of a channel occupancy time (COT); and participating in a sidelink (SL) communication in the unlicensed spectrum based on the COT.

Example 22 may include the method of example 21, and/or some other example herein, wherein the indication of the CAPC is identified in SL control information (SCI).

Example 23 may include the method of any of examples 21-22, and/or some other example herein, wherein the table includes a plurality of entries that correspond to different ones of a plurality of CAPC values.

Example 24 may include the method of example 23, and/or some other example herein, wherein the table is related to an uplink (UL) contention window (CW) size.

Example 25 may include the method of example 24, and/or some other example herein, wherein respective ones of the plurality of entries include a minimum CW size and a maximum CW size.

Example 26 may include the method of example 24, and/or some other example herein, wherein a length of the COT is based on a length of a CW that corresponds to the CAPC.

Example 27 may include the method of any of examples 21-26, and/or some other example herein, wherein participating in the SL communication includes transmitting a SL communication in the COT or identifying a SL communication that was received in the COT.

Example 28 may include a method to be performed by a user equipment (UE), one or more elements of a UE, and/or one or more electronic devices that include and/or implement a UE, wherein the method comprises: identifying, in sidelink (SL) control information (SCI), an indication of a channel access priority class (CAPC); identifying, based on the CAPC and a table, a length of a channel occupancy time (COT), wherein the table includes a plurality of entries that correspond to different ones of a plurality of CAPC values, wherein the table is related to the CAPC and an uplink (UL) contention window size (CWS); acquiring, based on the length of the COT, a COT for SL communication in the unlicensed spectrum; and participating in SL communication in the unlicensed spectrum based on the acquired COT.

Example 29 may include the method of example 28, and/or some other example herein, wherein the acquired COT is shared with a second UE.

Example 30 may include the method of example 29, and/or some other example herein, where the second UE is configured to transmit within the shared COT if its transmission is associated with a CAPC that is lower or equal to the CAPC or layer 1 (L1) priority of the UE.

Example 31 may include the method of example 30, and/or some other example herein, wherein the SCI further includes an indication of the L1 priority of the UE.

Example 32 may include the method of example 29, and/or some other example herein, wherein the SCI further includes an identifier of the second UE.

Example 33 may include the method of example 29, and/or some other example herein, wherein the SCI further includes an indication of time domain or frequency domain resources that may be usable by the second UE within the acquired COT.

Example 34 may include the method of any of examples 28-33, and/or some other example herein, wherein the UE is further to acquire the COT based on a listen before talk (LBT) procedure.

Example 35 may include the method of example 34, and/or some other example herein, wherein the SCI further includes an indication of a CAPC that is to be used by the UE when performing LBT to acquire the COT.

Example 36 may include the method of any of examples 28-35, and/or some other example herein, wherein if the SL communication is related to a SL secondary synchronization block (S-SSB), then the CAPC is a lowest CAPC of a plurality of CAPCs in the table.

Example 37 may include the method of any of examples 28-36, and/or some other example herein, wherein if the SL communication is related to a physical SL feedback channel (PSFCH) transmission, then the CAPC is a lowest CAPC of a plurality of CAPCs in the table.

Example 38 may include the method of any of examples 28-37, and/or some other example herein, wherein respective entries of the plurality of entries of the table include an indication of a minimum CWS, a maximum CWS, and a maximum COT length.

Example Z01 may include an apparatus comprising means to perform one or more elements of a method described in or related to any of examples 1-38, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-38, or any other method or process described herein.

Example Z03 may include an apparatus comprising logic, modules, or circuitry to perform one or more elements of a method described in or related to any of examples 1-38, or any other method or process described herein.

Example Z04 may include a method, technique, or process as described in or related to any of examples 1-38, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-38, or portions thereof.

Example Z06 may include a signal as described in or related to any of examples 1-38, or portions or parts thereof.

Example Z07 may include a datagram, packet, frame, segment, protocol data unit (PDU), or message as described in or related to any of examples 1-38, or portions or parts thereof, or otherwise described in the present disclosure.

Example Z08 may include a signal encoded with data as described in or related to any of examples 1-38, or portions or parts thereof, or otherwise described in the present disclosure.

Example Z09 may include a signal encoded with a datagram, packet, frame, segment, protocol data unit (PDU), or message as described in or related to any of examples 1-38, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-38, or portions thereof.

Example Z11 may include a computer program comprising instructions, wherein execution of the program by a processing element is to cause the processing element to carry out the method, techniques, or process as described in or related to any of examples 1-38, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third |
| | Generation |
| | Partnership |
| | Project |
| 4G | Fourth |
| | Generation |
| 5G | Fifth |
| | Generation |
| 5GC | 5G Core |
| | network |
| AC | Application |
| | Client |
| ACR | Application |
| | Context Relocation |
| ACK | Acknowledgement |
| ACID | Application |
| | Client Identification |
| AF | Application |
| | Function |
| AM | Acknowledged |
| | Mode |
| AMBR | Aggregate |
| | Maximum Bit Rate |
| AMF | Access and |
| | Mobility |
| | Management |
| | Function |
| AN | Access |
| | Network |
| ANR | Automatic |
| | Neighbour Relation |
| AOA | Angle of |
| | Arrival |
| AP | Application |
| | Protocol, Antenna |
| | Port, Access Point |
| API | Application |
| | Programming Interface |
| APN | Access Point |
| | Name |
| ARP | Allocation and |
| | Retention Priority |
| ARQ | Automatic |
| | Repeat Request |
| AS | Access Stratum |
| ASP | Application Service |
| | Provider |
| ASN.1 | Abstract Syntax |
| | Notation One |
| AUSF | Authentication |
| | Server Function |
| AWGN | Additive |
| | White Gaussian |
| | Noise |
| BAP | Backhaul |
| | Adaptation Protocol |
| BCH | Broadcast |
| | Channel |
| BER | Bit Error Ratio |
| BFD | Beam |
| | Failure Detection |
| BLER | Block Error |
| | Rate |
| BPSK | Binary Phase |
| | Shift Keying |
| BRAS | Broadband |
| | Remote Access |
| | Server |
| BSS | Business |
| | Support System |
| BS | Base Station |
| BSR | Buffer Status |
| | Report |
| BW | Bandwidth |
| BWP | Bandwidth Part |
| C-RNTI | Cell |
| | Radio Network |
| | Temporary |
| | Identity |
| CA | Carrier |
| | Aggregation, |
| | Certification |
| | Authority |
| CAPEX | CAPital |
| | EXpenditure |
| CBRA | Contention |
| | Based Random |
| | Access |
| CC | Component |
| | Carrier, Country |
| | Code, Cryptographic |
| | Checksum |
| CCA | Clear Channel |
| | Assessment |
| CCE | Control |
| | Channel Element |
| CCCH | Common |
| | Control Channel |
| CE | Coverage |
| | Enhancement |
| CDM | Content |
| | Delivery Network |
| CDMA | Code- |
| | Division Multiple |
| | Access |
| CDR | Charging Data |
| | Request |
| CDR | Charging Data |
| | Response |
| CFRA | Contention Free |
| | Random Access |
| CG | Cell Group |
| CGF | Charging |
| | Gateway Function |
| CHF | Charging |
| | Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, |
| | Conditional |
| | Mandatory |
| CMAS | Commercial |
| | Mobile Alert Service |
| CMD | Command |
| CMS | Cloud |
| | Management System |
| CO | Conditional |
| | Optional |
| CoMP | Coordinated |
| | Multi-Point |
| CORESET | Control |
| | Resource Set |
| COTS | Commercial |
| | Off-The-Shelf |
| CP | Control Plane, |
| | Cyclic Prefix, |
| | Connection |
| | Point |
| CPD | Connection |
| | Point Descriptor |
| CPE | Customer |
| | Premise |
| | Equipment |
| CPICH | Common Pilot |
| | Channel |
| CQI | Channel |
| | Quality Indicator |
| CPU | CSI processing |
| | unit, Central |
| | Processing Unit |
| C/R | Command/Response |
| | field bit |
| CRAN | Cloud Radio |
| | Access |
| | Network, Cloud |
| | RAN |
| CRB | Common |
| | Resource Block |
| CRC | Cyclic |
| | Redundancy Check |
| CRI | Channel-State |
| | Resource |
| | Indicator, CSI-RS |
| | Resource |
| | Indicator |
| C-RNTI | Cell |
| | RNTI |
| CS | Circuit |
| | Switched |
| CSCF | call |
| | session control function |
| CSAR | Cloud Service |
| | Archive |
| CSI | Channel-State |
| | Information |
| CSI-IM | CSI |
| | Interference |
| | Measurement |
| CSI-RS | CSI |
| | Reference Signal |
| CSI-RSRP | CSI |
| | reference signal |
| | received power |
| CSI-RSRQ | CSI |
| | reference signal |
| | received quality |
| CSI-SINR | CSI |
| | signal-to-noise and |
| | interference |
| | ratio |
| CSMA | Carrier Sense |
| | Multiple Access |
| CSMA/CA | CSMA |
| | with collision |
| | avoidance |
| CSS | Common |
| | Search Space, Cell- |
| | specific Search |
| | Space |
| CTF | Charging |
| | Trigger Function |
| CTS | Clear-to-Send |
| CW | Codeword |
| CWS | Contention |
| | Window Size |
| D2D | Device-to- |
| | Device |
| DC | Dual |
| | Connectivity, Direct |
| | Current |
| DCI | Downlink |
| | Control |
| | Information |
| DF | Deployment |
| | Flavour |
| DL | Downlink |
| DMTF | Distributed |
| | Management Task |
| | Force |
| DPDK | Data Plane |
| | Development Kit |
| DM-RS, DMRS | Demodulation |
| | Reference Signal |
| DN | Data network |
| DNN | Data Network |
| | Name |
| DNAI | Data Network |
| | Access Identifier |
| DRB | Data Radio |
| | Bearer |
| DRS | Discovery |
| | Reference Signal |
| DRX | Discontinuous |
| | Reception |
| DSL | Domain |
| | Specific Language. |
| | Digital |
| | Subscriber Line |
| DSLAM | DSL |
| | Access Multiplexer |
| DwPTS | Downlink Pilot |
| | Time Slot |
| E-LAN | Ethernet |
| | Local Area Network |
| E2E | End-to-End |
| EAS | Edge |
| | Application Server |
| ECCA | extended clear |
| | channel |
| | assessment, |
| | extended CCA |
| ECCE | Enhanced |
| | Control Channel |
| | Element, |
| | Enhanced CCE |
| ED | Energy |
| | Detection |
| EDGE | Enhanced |
| | Datarates for GSM |
| | Evolution |
| | (GSM Evolution) |
| EAS | Edge |
| | Application Server |
| EASID | Edge |
| | Application Server |
| | Identification |
| ECS | Edge |
| | Configuration Server |
| ECSP | Edge |
| | Computing Service |
| | Provider |
| EDN | Edge |
| | Data Network |
| EEC | Edge |
| | Enabler Client |
| EECID | Edge |
| | Enabler Client |
| | Identification |
| EES | Edge |
| | Enabler Server |
| EESID | Edge |
| | Enabler Server |
| | Identification |
| EHE | Edge |
| | Hosting Environment |
| EGMF | Exposure |
| | Governance |
| | Management |
| | Function |
| EGPRS | Enhanced |
| | GPRS |
| EIR | Equipment |
| | Identity Register |
| eLAA | enhanced |
| | Licensed Assisted |
| | Access, |
| | enhanced LAA |
| EM | Element |
| | Manager |
| eMBB | Enhanced |
| | Mobile |
| | Broadband |
| EMS | Element |
| | Management System |
| eNB | evolved NodeB, |
| E-UTRAN | Node B |
| EN-DC | E- |
| | UTRA-NR Dual |
| | Connectivity |
| EPC | Evolved Packet |
| | Core |
| EPDCCH | enhanced |
| | PDCCH, enhanced |
| | Physical |
| | Downlink Control |
| | Cannel |
| EPRE | Energy per |
| | resource element |
| EPS | Evolved Packet |
| | System |
| EREG | enhanced REG, |
| | enhanced resource |
| | element groups |
| ETSI | European |
| | Telecommunications |
| | Standards |
| | Institute |
| ETWS | Earthquake and |
| | Tsunami Warning |
| | System |
| eUICC | embedded |
| | UICC, embedded |
| | Universal |
| | Integrated Circuit |
| | Card |
| E-UTRA | Evolved |
| | UTRA |
| E-UTRAN | Evolved |
| | UTRAN |
| EV2X | Enhanced V2X |
| F1AP | F1 Application |
| | Protocol |
| F1-C | F1 Control |
| | plane interface |
| F1-U | F1 User plane |
| | interface |
| FACCH | Fast |
| | Associated Control |
| | CHannel |
| FACCH/F | Fast |
| | Associated Control |
| | Channel/Full |
| | rate |
| FACCH/H | Fast |
| | Associated Control |
| | Channel/Half |
| | rate |
| FACH | Forward Access |
| | Channel |
| FAUSCH | Fast |
| | Uplink Signalling |
| | Channel |
| FB | Functional |
| | Block |
| FBI | Feedback |
| | Information |
| FCC | Federal |
| | Communications |
| | Commission |
| FCCH | Frequency |
| | Correction CHannel |
| FDD | Frequency |
| | Division Duplex |
| FDM | Frequency |
| | Division |
| | Multiplex |
| FDMA | Frequency |
| | Division Multiple |
| | Access |
| FE | Front End |
| FEC | Forward Error |
| | Correction |
| FFS | For Further |
| | Study |
| FFT | Fast Fourier |
| | Transformation |
| feLAA | further |
| | enhanced Licensed |
| | Assisted |
| | Access, further |
| | enhanced LAA |
| FN | Frame Number |
| FPGA | Field- |
| | Programmable Gate |
| | Array |
| FR | Frequency |
| | Range |
| FQDN | Fully |
| | Qualified Domain |
| | Name |
| G-RNTI | GERAN |
| | Radio Network |
| | Temporary |
| | Identity |
| GERAN | GSM EDGE |
| | RAN, GSM EDGE |
| | Radio Access |
| | Network |
| GGSN | Gateway GPRS |
| | Support Node |
| GLONASS | GLObal'naya |
| | NAvigatsionnay |
| | a Sputnikovaya |
| | Sistema (Engl.: |
| | Global Navigation |
| | Satellite |
| | System) |
| gNB | Next |
| | Generation NodeB |
| gNB-CU | gNB- |
| | centralized unit, Next |
| | Generation |
| | NodeB |
| | centralized unit |
| gNB-DU | gNB- |
| | distributed unit, Next |
| | Generation |
| | NodeB |
| | distributed unit |
| GNSS | Global |
| | Navigation Satellite |
| | System |
| GPRS | General Packet |
| | Radio Service |
| GPSI | Generic |
| | Public Subscription |
| | Identifier |
| GSM | Global System |
| | for Mobile |
| | Communications, |
| | Groupe Spécial |
| | Mobile |
| GTP | GPRS |
| | Tunneling Protocol |
| GTP-UGPRS | Tunnelling Protocol |
| | for User Plane |
| GTS | Go To Sleep |
| | Signal (related |
| | to WUS) |
| GUMMEI | Globally |
| | Unique MME |
| | Identifier |
| GUTI | Globally |
| | Unique Temporary |
| | UE Identity |
| HARQ | Hybrid ARQ, |
| | Hybrid |
| | Automatic |
| | Repeat Request |
| HANDO | Handover |
| HFN | HyperFrame |
| | Number |
| HHO | Hard Handover |
| HLR | Home Location |
| | Register |
| HN | Home Network |
| HO | Handover |
| HPLMN | Home |
| | Public Land Mobile |
| | Network |
| HSDPA | High |
| | Speed Downlink |
| | Packet Access |
| HSN | Hopping |
| | Sequence Number |
| HSPA | High Speed |
| | Packet Access |
| HSS | Home |
| | Subscriber Server |
| HSUPA | High |
| | Speed Uplink Packet |
| | Access |
| HTTP | Hyper Text |
| | Transfer Protocol |
| HTTPS | Hyper |
| | Text Transfer Protocol |
| | Secure (https is |
| | http/1.1 over |
| | SSL, i.e. port 443) |
| | I-Block |
| | Information |
| | Block |
| ICCID | Integrated |
| | Circuit Card |
| | Identification |
| IAB | Integrated |
| | Access and |
| | Backhaul |
| ICIC | Inter-Cell |
| | Interference |
| | Coordination |
| ID | Identity, |
| | identifier |
| IDFT | Inverse Discrete |
| | Fourier |
| | Transform |
| IE | Information |
| | element |
| IBE | In-Band |
| | Emission |
| IEEE | Institute of |
| | Electrical and |
| | Electronics |
| | Engineers |
| IEI | Information |
| | Element |
| | Identifier |
| IEIDL | Information |
| | Element |
| | Identifier Data |
| | Length |
| IETF | Internet |
| | Engineering Task |
| | Force |
| IF | Infrastructure |
| IIOT | Industrial |
| | Internet of Things |
| IM | Interference |
| | Measurement, |
| | Intermodulation, |
| | IP Multimedia |
| IMC | IMS |
| | Credentials |
| IMEI | International |
| | Mobile |
| | Equipment |
| | Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile |
| | Subscriber |
| | Identity |
| IoT | Internet of |
| | Things |
| IP | Internet |
| | Protocol |
| Ipsec | IP Security, |
| | Internet Protocol |
| | Security |
| IP-CAN | IP- |
| | Connectivity Access |
| | Network |
| IP-M | IP Multicast |
| IPv4 | Internet |
| | Protocol Version 4 |
| IPv6 | Internet |
| | Protocol Version 6 |
| IR | Infrared |
| IS | In Sync |
| IRP | Integration |
| | Reference Point |
| ISDN | Integrated |
| | Services Digital |
| | Network |
| ISIM | IM Services |
| | Identity Module |
| ISO | International |
| | Organisation for |
| | Standardisation |
| ISP | Internet Service |
| | Provider |
| IWF | Interworking- |
| | Function |
| I-WLAN | Interworking |
| | WLAN |
| | Constraint |
| | length of the |
| | convolutional |
| | code, USIM |
| | Individual key |
| kB | Kilobyte (1000 |
| | bytes) |
| kbps | kilo-bits per |
| | second |
| Kc | Ciphering key |
| Ki | Individual |
| | subscriber |
| | authentication |
| | key |
| KPI | Key |
| | Performance Indicator |
| KQI | Key Quality |
| | Indicator |
| KSI | Key Set |
| | Identifier |
| ksps | kilo-symbols |
| | per second |
| KVM | Kernel Virtual |
| | Machine |
| L1 | Layer 1 |
| | (physical layer) |
| L1-RSRP | Layer 1 |
| | reference signal |
| | received power |
| L2 | Layer 2 (data |
| | link layer) |
| L3 | Layer 3 |
| | (network layer) |
| LAA | Licensed |
| | Assisted Access |
| LAN | Local Area |
| | Network |
| LADN | Local |
| | Area Data Network |
| LBT | Listen Before |
| | Talk |
| LCM | LifeCycle |
| | Management |
| LCR | Low Chip Rate |
| LCS | Location |
| | Services |
| LCID | Logical |
| | Channel ID |
| LI | Layer Indicator |
| LLC | Logical Link |
| | Control, Low Layer |
| | Compatibility |
| LMF | Location |
| | Management Function |
| LOS | Line of |
| | Sight |
| LPLMN | Local |
| | PLMN |
| LPP | LTE |
| | Positioning Protocol |
| LSB | Least |
| | Significant Bit |
| LTE | Long Term |
| | Evolution |
| LWA | LTE-WLAN |
| | aggregation |
| LWIP | LTE/WLAN |
| | Radio Level |
| | Integration with |
| | IPsec Tunnel |
| LTE | Long Term |
| | Evolution |
| M2M | Machine-to- |
| | Machine |
| MAC | Medium Access |
| | Control |
| | (protocol |
| | layering context) |
| MAC | Message |
| | authentication code |
| | (security/encryption |
| | context) |
| MAC-A | MAC |
| | used for |
| | authentication |
| | and key |
| | agreement |
| | (TSG T WG3 context) |
| MAC-IMAC | used for |
| | data integrity of |
| | signalling messages |
| | (TSG T WG3 context) |
| MANO | Management |
| | and Orchestration |
| MBMS | Multimedia |
| | Broadcast and |
| | Multicast |
| | Service |
| MBSFN | Multimedia |
| | Broadcast |
| | multicast |
| | service Single |
| | Frequency |
| | Network |
| MCC | Mobile Country |
| | Code |
| MCG | Master Cell |
| | Group |
| MCOT | Maximum |
| | Channel |
| | Occupancy |
| | Time |
| MCS | Modulation and |
| | coding scheme |
| MDAF | Management |
| | Data Analytics |
| | Function |
| MDAS | Management |
| | Data Analytics |
| | Service |
| MDT | Minimization of |
| | Drive Tests |
| ME | Mobile |
| | Equipment |
| MeNB | master eNB |
| MER | Message Error |
| | Ratio |
| MGL | Measurement |
| | Gap Length |
| MGRP | Measurement |
| | Gap Repetition |
| | Period |
| MIB | Master |
| | Information Block, |
| | Management |
| | Information Base |
| MIMO | Multiple Input |
| | Multiple Output |
| MLC | Mobile |
| | Location Centre |
| MM | Mobility |
| | Management |
| MME | Mobility |
| | Management Entity |
| MN | Master Node |
| MNO | Mobile |
| | Network Operator |
| MO | Measurement |
| | Object, Mobile |
| | Originated |
| MPBCH | MTC |
| | Physical Broadcast |
| | CHannel |
| MPDCCH | MTC |
| | Physical Downlink |
| | Control |
| | CHannel |
| MPDSCH | MTC |
| | Physical Downlink |
| | Shared |
| | CHannel |
| MPRACH | MTC |
| | Physical Random |
| | Access |
| | CHannel |
| MPUSCH | MTC |
| | Physical Uplink Shared |
| | Channel |
| MPLS | MultiProtocol |
| | Label Switching |
| MS | Mobile Station |
| MSB | Most |
| | Significant Bit |
| MSC | Mobile |
| | Switching Centre |
| MSI | Minimum |
| | System |
| | Information, |
| MCH | Scheduling |
| | Information |
| MSID | Mobile Station |
| | Identifier |
| MSIN | Mobile Station |
| | Identification |
| | Number |
| MSISDN | Mobile |
| | Subscriber ISDN |
| | Number |
| MT | Mobile |
| | Terminated, Mobile |
| | Termination |
| MTC | Machine-Type |
| | Communications |
| mMTC | massive MTC, |
| | massive |
| | Machine-Type |
| | Communications |
| MU-MIMO | Multi |
| | User MIMO |
| MWUS | MTC |
| | wake-up signal, MTC |
| | WUS |
| NACK | Negative |
| | Acknowledgement |
| NAI | Network |
| | Access Identifier |
| NAS | Non-Access |
| | Stratum, Non-Access |
| | Stratum layer |
| NCT | Network |
| | Connectivity |
| | Topology |
| NC-JT | Non- |
| | Coherent Joint |
| | Transmission |
| NEC | Network |
| | Capability |
| | Exposure |
| NE-DC | NR-E- |
| | UTRA Dual |
| | Connectivity |
| NEF | Network |
| | Exposure Function |
| NF | Network |
| | Function |
| NFP | Network |
| | Forwarding Path |
| NFPD | Network |
| | Forwarding Path |
| | Descriptor |
| NFV | Network |
| | Functions |
| | Virtualization |
| NFVI | NFV |
| | Infrastructure |
| NFVO | NFV |
| | Orchestrator |
| NG | Next |
| | Generation, Next Gen |
| NGEN-DC | NG- |
| | RAN E-UTRA-NR |
| | Dual Connectivity |
| NM | Network |
| | Manager |
| NMS | Network |
| | Management System |
| N-PoP | Network Point |
| | of Presence |
| NMIB, N-MIB | Narrowband MIB |
| NPBCH | Narrowband |
| | Physical |
| | Broadcast |
| | CHannel |
| NPDCCH | Narrowband |
| | Physical |
| | Downlink |
| | Control CHannel |
| NPDSCH | Narrowband |
| | Physical |
| | Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network |
| | Service |
| NSA | Non-Standalone |
| | operation mode |
| NSD | Network |
| | Service Descriptor |
| NSR | Network |
| | Service Record |
| NSSAI | Network Slice |
| | Selection |
| | Assistance |
| | Information |
| S-NNSAI | Single- |
| | NSSAI |
| NSSF | Network Slice |
| | Selection Function |
| NW | Network |
| NWUS | Narrowband |
| | wake-up signal, |
| | Narrowband WUS |
| NZP | Non-Zero |
| | Power |
| O&M | Operation and |
| | Maintenance |
| ODU2 | Optical channel |
| | Data Unit-type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of |
| | Sync |
| OPEX | OPerating |
| | EXpense |
| OSI | Other System |
| | Information |
| OSS | Operations |
| | Support System |
| OTA | over-the-air |
| PAPR | Peak-to- |
| | Average Power |
| | Ratio |
| PAR | Peak to |
| | Average Ratio |
| PBCH | Physical |
| | Broadcast Channel |
| PC | Power Control, |
| | Personal |
| | Computer |
| PCC | Primary |
| | Component Carrier, |
| | Primary CC |
| P-CSCF | Proxy |
| | CSCF |
| PCell | Primary Cell |
| PCI | Physical Cell |
| | ID, Physical Cell |
| | Identity |
| PCEF | Policy and |
| | Charging |
| | Enforcement |
| | Function |
| PCF | Policy Control |
| | Function |
| PCRF | Policy Control |
| | and Charging Rules |
| | Function |
| PDCP | Packet Data |
| | Convergence |
| | Protocol, Packet |
| | Data Convergence |
| | Protocol layer |
| PDCCH | Physical |
| | Downlink Control |
| | Channel |
| PDCP | Packet Data |
| | Convergence Protocol |
| PDN | Packet Data |
| | Network, Public |
| | Data Network |
| PDSCH | Physical |
| | Downlink Shared |
| | Channel |
| PDU | Protocol Data |
| | Unit |
| PEI | Permanent |
| | Equipment |
| | Identifiers |
| PFD | Packet Flow |
| | Description |
| P-GW | PDN Gateway |
| PHICH | Physical |
| | hybrid-ARQ indicator |
| | channel |
| PHY | Physical layer |
| PLMN | Public Land |
| | Mobile Network |
| PIN | Personal |
| | Identification Number |
| PM | Performance |
| | Measurement |
| PMI | Precoding |
| | Matrix Indicator |
| PNF | Physical |
| | Network Function |
| PNFD | Physical |
| | Network Function |
| | Descriptor |
| PNFR | Physical |
| | Network Function |
| | Record |
| POC | PTT over |
| | Cellular |
| PP, PTP | Point-to- |
| | Point |
| PPP | Point-to-Point |
| | Protocol |
| PRACH | Physical |
| | RACH |
| PRB | Physical |
| | resource block |
| PRG | Physical |
| | resource block |
| | group |
| ProSe | Proximity |
| | Services, |
| | Proximity- |
| | Based Service |
| PRS | Positioning |
| | Reference Signal |
| PRR | Packet |
| | Reception Radio |
| PS | Packet Services |
| PSBCH | Physical |
| | Sidelink Broadcast |
| | Channel |
| PSDCH | Physical |
| | Sidelink Downlink |
| | Channel |
| PSCCH | Physical |
| | Sidelink Control |
| | Channel |
| PSSCH | Physical |
| | Sidelink Shared |
| | Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical |
| | Uplink Shared |
| | Channel |
| QAM | Quadrature |
| | Amplitude |
| | Modulation |
| QCI | QoS class of |
| | identifier |
| QCL | Quasi co- |
| | location |
| QFI | QoS Flow ID, |
| | QoS Flow |
| | Identifier |
| QoS | Quality of |
| | Service |
| QPSK | Quadrature |
| | (Quaternary) Phase |
| | Shift Keying |
| QZSS | Quasi-Zenith |
| | Satellite System |
| RA-RNTI | Random |
| | Access RNTI |
| RAB | Radio Access |
| | Bearer, Random |
| | Access Burst |
| RACH | Random Access |
| | Channel |
| RADIUS | Remote |
| | Authentication Dial |
| | In User Service |
| RAN | Radio Access |
| | Network |
| RAND | RANDom |
| | number (used for |
| | authentication) |
| RAR | Random Access |
| | Response |
| RAT | Radio Access |
| | Technology |
| RAU | Routing Area |
| | Update |
| RB | Resource block, |
| | Radio Bearer |
| RBG | Resource block |
| | group |
| REG | Resource |
| | Element Group |
| Rel | Release |
| REQ | REQuest |
| RF | Radio |
| | Frequency |
| RI | Rank Indicator |
| RIV | Resource |
| | indicator value |
| RL | Radio Link |
| RLC | Radio Link |
| | Control, Radio |
| | Link Control |
| | layer |
| RLC AM | RLC |
| | Acknowledged Mode |
| RLC UM | RLC |
| | Unacknowledged |
| | Mode |
| RLF | Radio Link |
| | Failure |
| RLM | Radio Link |
| | Monitoring |
| RLM-RS | Reference |
| | Signal for RLM |
| RM | Registration |
| | Management |
| RMC | Reference |
| | Measurement Channel |
| RMSI | Remaining |
| | MSI, Remaining |
| | Minimum |
| | System |
| | Information |
| RN | Relay Node |
| RNC | Radio Network |
| | Controller |
| RNL | Radio Network |
| | Layer |
| RNTI | Radio Network |
| | Temporary |
| | Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference |
| | Signal |
| RSRP | Reference |
| | Signal Received |
| | Power |
| RSRQ | Reference |
| Signal | Received |
| | Quality |
| RSSI | Received Signal |
| | Strength |
| | Indicator |
| RSU | Road Side Unit |
| RSTD | Reference |
| | Signal Time |
| | difference |
| RTP | Real Time |
| | Protocol |
| RTS | Ready-To-Send |
| RTT | Round Trip |
| | Time |
| Rx | Reception, |
| | Receiving, Receiver |
| S1AP | S1 Application |
| | Protocol |
| S1-MME | S1 for |
| | the control plane |
| S1-U | S1 for the user |
| | plane |
| S-CSCF | serving |
| | CSCF |
| S-GW | Serving |
| | Gateway |
| S-RNTI | SRNC |
| | Radio Network |
| | Temporary |
| | Identity |
| S-TMSI | SAE |
| | Temporary Mobile |
| | Station |
| | Identifier |
| SA | Standalone |
| | operation mode |
| SAE | System |
| | Architecture |
| | Evolution |
| SAP | Service Access |
| | Point |
| SAPD | Service Access |
| | Point Descriptor |
| SAPI | Service Access |
| | Point Identifier |
| SCC | Secondary |
| | Component Carrier, |
| | Secondary CC |
| SCell | Secondary Cell |
| SCEF | Service |
| | Capability Exposure |
| | Function |
| SC-FDMA | Single |
| | Carrier Frequency |
| | Division |
| | Multiple Access |
| SCG | Secondary Cell |
| | Group |
| SCM | Security |
| | Context |
| | Management |
| SCS | Subcarrier |
| | Spacing |
| SCTP | Stream Control |
| | Protocol |
| SDAP | Service Data |
| | Adaptation |
| | Protocol, |
| | Service Data |
| | Adaptation |
| | Protocol layer |
| SDL | Supplementary |
| | Downlink |
| SDNF | Structured Data |
| | Storage Network |
| | Function |
| SDP | Session |
| | Description Protocol |
| SDSF | Structured Data |
| | Storage Function |
| SDT | Small Data |
| | Transmission |
| SDU | Service Data |
| | Unit |
| SEAF | Security |
| | Anchor Function |
| SeNB | secondary eNB |
| SEPP | Security Edge |
| | Protection Proxy |
| SFI | Slot format |
| | indication |
| SFTD | Space- |
| | Frequency Time |
| | Diversity, SFN |
| | and frame timing |
| | difference |
| SFN | System Frame |
| | Number |
| SgNB | Secondary gNB |
| SGSN | Serving GPRS |
| | Support Node |
| S-GW | Serving |
| | Gateway |
| SI | System |
| | Information |
| SI-RNTI | System |
| | Information RNTI |
| SIB | System |
| | Information Block |
| SIM | Subscriber |
| | Identity Module |
| SIP | Session |
| | Initiated Protocol |
| SiP | System in |
| | Package |
| SL | Sidelink |
| SLA | Service Level |
| | Agreement |
| SM | Session |
| | Management |
| SMF | Session |
| | Management Function |
| SMS | Short Message |
| | Service |
| SMSF | SMS Function |
| SMTC | SSB-based |
| | Measurement Timing |
| | Configuration |
| SN | Secondary |
| | Node, Sequence |
| | Number |
| SoC | System on Chip |
| SON | Self-Organizing |
| | Network |
| SpCell | Special Cell |
| SP-CSI-RNTI | Semi- |
| | Persistent CSI RNTI |
| SPS | Semi-Persistent |
| | Scheduling |
| SQN | Sequence |
| | number |
| SR | Scheduling |
| | Request |
| SRB | Signalling |
| | Radio Bearer |
| SRS | Sounding |
| | Reference Signal |
| SS | Synchronization |
| | Signal |
| SSB | Synchronization |
| | Signal Block |
| SSID | Service Set |
| | Identifier |
| SS/PBCH | Block |
| SSBRI | SS/PBCH |
| | Block Resource |
| | Indicator, |
| | Synchronization |
| | Signal Block |
| | Resource |
| | Indicator |
| SSC | Session and |
| | Service |
| | Continuity |
| SS-RSRP | Synchronization |
| | Signal based |
| | Reference |
| | Signal Received |
| | Power |
| SS-RSRQ | Synchronization |
| | Signal based |
| | Reference |
| | Signal Received |
| | Quality |
| SS-SINR | Synchronization |
| | Signal based Signal |
| | to Noise and |
| | Interference Ratio |
| SSS | Secondary |
| | Synchronization |
| | Signal |
| SSSG | Search Space |
| | Set Group |
| SSSIF | Search Space |
| | Set Indicator |
| SST | Slice/Service |
| | Types |
| SU-MIMO | Single |
| | User MIMO |
| SUL | Supplementary |
| | Uplink |
| TA | Timing |
| | Advance, Tracking |
| | Area |
| TAC | Tracking Area |
| | Code |
| TAG | Timing |
| | Advance Group |
| TAI | Tracking Area |
| | Identity |
| TAU | Tracking Area |
| | Update |
| TB | Transport Block |
| TBS | Transport Block |
| | Size |
| TBD | To Be Defined |
| TCI | Transmission |
| | Configuration |
| | Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal |
| | Equipment |
| TEID | Tunnel End |
| | Point Identifier |
| TFT | Traffic Flow |
| | Template |
| TMSI | Temporary |
| | Mobile |
| | Subscriber |
| | Identity |
| TNL | Transport |
| | Network Layer |
| TPC | Transmit Power |
| | Control |
| TPMI | Transmitted |
| | Precoding Matrix |
| | Indicator |
| TR | Technical |
| | Report |
| TRP, TRxP | Transmission |
| | Reception Point |
| TRS | Tracking |
| | Reference Signal |
| TRx | Transceiver |
| TS | Technical |
| | Specifications, |
| | Technical |
| | Standard |
| TTI | Transmission |
| | Time Interval |
| Tx | Transmission, |
| | Transmitting, |
| | Transmitter |
| U-RNTI | UTRAN |
| | Radio Network |
| | Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured |
| | Data Storage Network |
| | Function |
| UICC | Universal |
| | Integrated Circuit |
| | Card |
| UL | Uplink |
| UM | Unacknowledged |
| | Mode |
| UML | Unified |
| | Modelling Language |
| UMTS | Universal |
| | Mobile |
| | Telecommunications |
| | System |
| UP | User Plane |
| UPF | User Plane |
| | Function |
| URI | Uniform |
| | Resource Identifier |
| URL | Uniform |
| | Resource Locator |
| URLLC | Ultra- |
| | Reliable and Low |
| | Latency |
| USB | Universal Serial |
| | Bus |
| USIM | Universal |
| | Subscriber Identity |
| | Module |
| USS | UE-specific |
| | search space |
| UTRA | UMTS |
| | Terrestrial Radio |
| | Access |
| UTRAN | Universal |
| | Terrestrial Radio |
| | Access |
| | Network |
| UwPTS | Uplink |
| | Pilot Time Slot |
| V2I | Vehicle-to- |
| | Infrastruction |
| V2P | Vehicle-to- |
| | Pedestrian |
| V2V | Vehicle-to- |
| | Vehicle |
| V2X | Vehicle-to- |
| | everything |
| VIM | Virtualized |
| | Infrastructure Manager |
| VL | Virtual Link, |
| VLAN | Virtual LAN, |
| | Virtual Local Area |
| | Network |
| VM | Virtual |
| | Machine |
| VNF | Virtualized |
| | Network Function |
| VNFFG | VNF |
| | Forwarding Graph |
| VNFFGD | VNF |
| | Forwarding Graph |
| | Descriptor |
| VNFM | VNF Manager |
| VoIP | Voice-over-IP, |
| | Voice-over-Internet |
| | Protocol |
| VPLMN | Visited |
| | Public Land Mobile |
| | Network |
| VPN | Virtual Private |
| | Network |
| VRB | Virtual |
| | Resource Block |
| WiMAX | Worldwide |
| | Interoperability |
| | for Microwave |
| | Access |
| WLAN | Wireless Local |
| | Area Network |
| WMAN | Wireless |
| | Metropolitan Area |
| | Network |
| WPAN | Wireless |
| | Personal Area Network |
| X2-C | X2-Control |
| | plane |
| X2-U | X2-User plane |
| XML | eXtensible |
| | Markup |
| | Language |
| XRES | EXpected user |
| | RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An electronic device for use in a user equipment (UE), wherein the electronic device comprises:
memory to store a sidelink (SL) control information (SCI); and
one or more processors configured to:
identify, based on the SCI, an indication of a channel access priority class (CAPC);
identify, based on the CAPC and a table, a length of a channel occupancy time (COT), wherein the table includes a plurality of entries that correspond to different ones of a plurality of CAPC values, wherein the table is related to the CAPC and an uplink (UL) contention window size (CWS);
acquire, based on the length of the COT, a COT for SL communication in the unlicensed spectrum; and
facilitate participation by the UE in SL communication in the unlicensed spectrum based on the acquired COT.

22. The electronic device of claim 21, wherein the acquired COT is shared with a second UE.

23. The electronic device of claim 22, where the second UE is configured to transmit within the shared COT if its transmission is associated with a CAPC that is lower or equal to the CAPC or layer 1 (L1) priority of the UE.

24. The electronic device of claim 23, wherein the SCI further includes an indication of the L1 priority of the UE.

25. The electronic device of claim 22, wherein the SCI further includes an identifier of the second UE.

26. The electronic device of claim 22, wherein the SCI further includes an indication of time domain or frequency domain resources that may be usable by the second UE within the acquired COT.

27. The electronic device of claim 21, wherein the UE is further to acquire the COT based on a listen before talk (LBT) procedure.

28. The electronic device of claim 27, wherein the SCI further includes an indication of a CAPC that is to be used by the UE when performing LBT to acquire the COT.

29. The electronic device of claim 21, wherein if the SL communication is related to a SL secondary synchronization block (S-SSB), then the CAPC is a lowest CAPC of a plurality of CAPCs in the table.

30. The electronic device of claim 21, wherein if the SL communication is related to a physical SL feedback channel (PSFCH) transmission, then the CAPC is a lowest CAPC of a plurality of CAPCs in the table.

31. The electronic device of claim 21, wherein respective entries of the plurality of entries of the table include an indication of a minimum CWS, a maximum CWS, and a maximum COT length.

32. One or more non-transitory computer-readable media (NTCRM) comprising instructions that, upon execution of the instructions by one or more processors of a user equipment (UE), are to cause the UE to:
identify, in sidelink (SL) control information (SCI), an indication of a channel access priority class (CAPC);
identify, based on the CAPC and a table, a length of a channel occupancy time (COT), wherein the table includes a plurality of entries that correspond to different ones of a plurality of CAPC values, wherein the table is related to the CAPC and an uplink (UL) contention window size (CWS);
acquire, based on the length of the COT, a COT for SL communication in the unlicensed spectrum; and
participate in SL communication in the unlicensed spectrum based on the acquired COT.

33. The one or more NTCRM of claim 32, wherein the acquired COT is shared with a second UE.

34. The one or more NTCRM of claim 32, wherein the UE is further to acquire the COT based on a listen before talk (LBT) procedure.

35. The one or more NTCRM of claim 32, wherein if the SL communication is related to a SL secondary synchronization block (S-SSB) or a physical SL feedback channel (PSFCH) transmission, then the CAPC is a lowest CAPC of a plurality of CAPCs in the table.

36. The one or more NTCRM of claim 32, wherein respective entries of the plurality of entries of the table include an indication of a minimum CWS, a maximum CWS, and a maximum COT length.

37. A user equipment (UE), wherein the UE comprises:
radio frequency (RF) circuitry to transmit or receive one or more wireless signals; and
one or more processors coupled with the RF circuitry, wherein the one or more processors are to:
identify, in sidelink (SL) control information (SCI), an indication of a channel access priority class (CAPC);
identify, based on the CAPC and a table, a length of a channel occupancy time (COT), wherein the table includes a plurality of entries that correspond to different ones of a plurality of CAPC values, wherein the table is related to the CAPC and an uplink (UL) contention window size (CWS);
acquire, based on the length of the COT, a COT for SL communication in the unlicensed spectrum; and
participate, via the RF circuitry, in SL communication in the unlicensed spectrum based on the acquired COT.

38. The UE of claim 37, wherein the acquired COT is shared with a second UE.

39. The UE of claim 37, wherein the UE is further to acquire the COT based on a listen before talk (LBT) procedure.

40. The UE of claim 37, wherein respective entries of the plurality of entries of the table include an indication of a minimum CWS, a maximum CWS, and a maximum COT length.
